(19) United States
(12) Patent Application Publication
(10) Pub. No.: US 2025/0233370 A1
(43) Pub. Date: Jul. 17, 2025

(54) CONNECTOR AND CONNECTOR PAIR

(71) Applicant: Molex, LLC, Lisle, IL (US)

(72) Inventors: Ryunosuke Miyamoto, Yamato (JP); Makoto Shinyama, Yamato (JP)

(21) Appl. No.: 18/853,720

(22) PCT Filed: May 19, 2023
(86) PCT No.: PCT/IB2023/055175

§ 371 Date: Oct. 3, 2024

(30) Foreign Application Priority Data
Jun. 16, 2022 (JP) 2022-097565

(51) Int. Cl. H01R 13/6594; H01R 12/71; H01R 13/02; H01R 13/6581

(52) U.S. Cl. CPC H01R 13/6594; H01R 12/716; H01R 13/02; H01R 13/6581

(57) ABSTRACT

Terminals are arranged to form rows extending in a longitudinal direction of a connector. A shielding member includes a fixing part, a shielding plate, and a joint part. A fixing part integrally connects and fixes the shielding member to a connector main body with no gap in between, in vicinity of both ends of the connector main body in the longitudinal direction. The shielding plate is disposed on outer side of the connector main body in a width direction, in a range at least corresponding to the rows of the terminals, in the longitudinal direction of the connector, with a side space provided in between. The joint part connects the shielding plate to the connector main body across the side space in the range corresponding to the rows of the terminals.

### CROSS-REFERENCE TO RELATED APPLICATIONS

This international PCT patent application claims the benefit of priority to Japanese Patent Application No. 2022-097565, filed on Jun. 16, 2022. The above-referenced patent application is herein incorporated by reference in its entirety.

### TECHNICAL FIELD

The present disclosure relates to a connector and a connector pair.

### BACKGROUND ART

Known connectors such as board-to-board connectors have been used to electrically connect a pair of circuit boards to each other. Such connectors are attached to each of opposing surfaces of the pair of circuit boards, and fitted together to secure electric conduction. Furthermore, in order to reduce the influence of noise and radio waves from the outside and also to suppress the emission of noise and radio waves to the outside, a technique of providing a shielding member has been proposed (for example, refer to Patent Document 1).

FIG. 62 is a perspective view illustrating a known connector.

In the drawing, 811 is a connector housing mounted on a surface of a circuit board (not illustrated), which has a receiving recess 812 that receives a mating connector (not illustrated). The housing 811 includes a central wall portion 813 that is positioned at the center of the receiving recess 812 in the width direction and extends in the longitudinal direction, and a pair of side wall parts 814 that are positioned on both left and right sides of the central wall portion 813 and extend in the longitudinal direction.

Furthermore, a plurality of terminals 861 are respectively attached to the respective side wall parts 814 and are aligned in the longitudinal direction. Each terminal 861 includes a pair of contacting parts protruding from inner wall surfaces of the side wall parts 814 and the central wall portion 813 opposite to each other, and a connecting part 864 protruding outward from a lower end of the side wall part 814. The connecting part 864 is soldered to a connection pad formed on a surface of the circuit board. When the mating connector is received in the receiving recess 812, the contacting part comes into conductive contact with a terminal of the mating connector.

Furthermore, a conductive shielding plate 850 is attached to the housing 811 so as to entirely cover an outer wall surface of the side wall part 814. The shielding plate 850 has a plurality of substrate connecting parts 850a, and the substrate connecting parts 850a are soldered to the connection pad formed on a surface of the first circuit board. Thus, an outer circumferential surface of the housing 811 is covered by the conductive shielding plate 850. Therefore, an electromagnetic shielding action by the shielding plate 850 is achieved for the connector and for the mating connector received in the receiving recess 812.

Prior Art Documents: Patent Documents: Patent Document 1: Japanese Unexamined Patent Application 2011-119119.

### SUMMARY

However, this type of conventional connector can not handle the size reduction and increased signal speeds of recent electronic devices. In electronic devices such as laptop computers, tablets, smart phones, digital cameras, music players, game machines, navigation devices, and the like, a compact and low-profile housing and accompanying compact and low-profile components are required, and a high-speed signal and multipolarization are required to handle an increase in the amount of communication data and a higher communication speed and data processing speed. However, an attempt to pursue compact and low profile as well as multipolarization with the aforementioned known connector leads to the housing 811 that is thin and long and thus is likely to be warped, resulting in compromised flatness of the substrate connecting parts 850a of the shielding plate 850. Furthermore, the shielding plate 850 itself is likely to deform. All things considered, reliability in terms of connection between the substrate connecting parts 850a of the shielding plate 850 and the connection pads of the circuit board is compromised. Thus, an attempt to pursue compact and low profile as well as multipolarization with the aforementioned known connector results in the compromised reliability due to a failure to achieve a sufficient electromagnetic shielding effect.

Herein, in order to solve the problems of the conventional connector, an object of the present invention is to provide a highly reliable connector and connector pair that exhibit high strength and achieve a high shielding effect while having a compact and low profile.

In view of the above, a connector includes: a connector main body; a plurality of terminals attached to the connector main body; and a shielding member surrounding the connector main body, the connector mating with a mating connector. The terminals are arranged to form rows extending in a longitudinal direction of the connector. The shielding member includes a fixing part, a shielding plate, and a joint part. The fixing part integrally connects and fixes the shielding member to the connector main body with no gap in between, in vicinity of both ends of the connector main body in the longitudinal direction. The shielding plate is disposed on outer side of the connector main body in a width direction, in a range at least corresponding to the rows of the terminals, in the longitudinal direction of the connector, with a side space provided in between. The joint part connects the shielding plate to the connector main body across the side space in the range corresponding to the rows of the terminals.

Furthermore in another connector, the joint part extends from an upper end of the shielding plate toward a mounting surface of the connector, further extends toward the connector main body, and has a tip end fixed to the connector main body between ones of the terminals adjacent to each other in the longitudinal direction of the connector.

Furthermore, in another connector, part of the joint part is electrically connectable to a substrate on which the connector is mounted.

Furthermore, in another connector, a substrate connecting part parallel to a surface of a substrate on which the connector is mounted is formable on the shielding plate.

Furthermore, in another connector, the shielding member is able to include a second shielding member surrounding both ends of the connector main body in the longitudinal direction.

Furthermore, in another connector, the second shielding member is able to be integrated with the shielding member.

Furthermore, in another connector, the shielding member surrounds periphery of a housing part in which the mating connector is inserted and housed, the shielding plate includes at least two contacting parts configured to come into contact with a shielding plate of the mating connector, and the joint part is formed between adjacent ones of the contacting parts.

Furthermore, in another connector, the shielding plate is able to include a contact part formed to protrude outward from an outer surface.

Furthermore another connector includes a connector main body; a plurality of terminals attached to the connector main body; and a shielding member surrounding the connector main body, the connector mating with a mating connector. The terminals are arranged to form rows extending in a longitudinal direction of the connector. The shielding member has a substantially rectangular shape in plan view, and has four sides configured to come into contact with a shielding member of the mating connector. The connector includes contact pieces that are disposed in vicinity of four corner parts of the shielding member and are elastically displaceable in a mating direction. The contact pieces are configured to come into contact with the shielding member of the mating connector.

Furthermore, in another connector, contact points of the contact pieces are configured to come into contact with the shielding member of the mating connector outside a region where the four sides of the shielding member come into contact with the shielding member of the mating connector in plan view.

Furthermore, in another connector, the contact pieces are connected to the shielding member.

Furthermore, in another connector, the contact pieces have a cantilever shape extending in the longitudinal direction of the connector.

Furthermore, in another connector, the shielding member of the mating connector includes a shield upper surface part disposed on an upper surface of a connector main body of the mating connector, and the contact pieces are configured to come into contact with the shield upper surface part.

A connector pair consists of a connector according to the present disclosure and a mating connector that mates with the connector.

According to the present disclosure, a connector and connector pair can exhibit high strength, achieve a high shielding effect, and have improved reliability while having a compact and low profile.

### BRIEF DESCRIPTION OF THE DRAWINGS

FIG. 1 is a perspective view illustrating a first connector according to Embodiment 1, where FIG. 1A is a view seen obliquely from above, and FIG. 1B is a view seen obliquely from below.

FIG. 2 is a top view illustrating the first connector according to Embodiment 1.

FIG. 3 includes three views of the first connector according to Embodiment 1, where FIG. 3A is a side view, FIG. 3B is a bottom view, and FIG. 3C is a front view.

FIG. 4 is an exploded perspective view of the first connector according to Embodiment 1.

FIG. 5 is a side cross-sectional view of the first connector according to Embodiment 1, and is a cross-sectional view taken along a line indicated by arrows A-A in FIG. 2.

FIG. 6 is a traverse cross-sectional view of the first connector according to Embodiment 1, where FIG. 6A is a cross-sectional view taken along a line indicated by arrows B-B in FIG. 2, FIG. 6B is a cross-sectional view taken along a line indicated by arrows C-C in FIG. 2, and FIG. 6C is a cross-sectional view taken along a line indicated by arrows D-D in FIG. 2.

FIG. 7 is a first perspective one-side cross-sectional view of the first connector according to Embodiment 1, and is a perspective one-side cross-sectional view taken along line A-A in FIG. 2.

FIG. 8 is a second perspective one-side cross-sectional view of the first connector according to Embodiment 1, and is perspective one-side cross-sectional view taken along line B-B in FIG. 2.

FIG. 9 is a third perspective one-side cross-sectional view of the first connector according to Embodiment 1, and is perspective one-side cross-sectional view taken along line C-C in FIG. 2.

FIG. 10 is a fourth perspective one-side cross-sectional view of the first connector according to Embodiment 1, and is perspective one-side cross-sectional view taken along line D-D in FIG. 2.

FIG. 11 is a perspective view illustrating a second connector according to Embodiment 1, where FIG. 11A is a view seen obliquely from below, and FIG. 11B is a view seen obliquely from above.

FIG. 12 is a top view illustrating the second connector according to Embodiment 1.

FIG. 13 includes three views of a second connector according to Embodiment 1, where FIG. 13A is a side view, FIG. 13B is a bottom view, and FIG. 13C is a front view.

FIG. 14 is an exploded perspective view of the second connector according to Embodiment 1.

FIG. 15 is a side cross-sectional view of the second connector according to Embodiment 1, and is a cross-sectional view taken along a line indicated by arrows E-E in FIG. 12.

FIG. 16 is a traverse cross-sectional view of the second connector according to Embodiment 1, where FIG. 16A is a cross-sectional view taken along a line indicated by arrows F-F in FIG. 12, FIG. 16B is a cross-sectional view taken along a line indicated by arrows G-G in FIG. 12, and FIG. 16C is a cross-sectional view taken along a line indicated by arrows H-H in FIG. 12.

FIG. 17 is a first perspective one-side cross-sectional view of the second connector according to Embodiment 1, and is perspective one-side cross-sectional view taken along line E-E in FIG. 12.

FIG. 18 is a second perspective one-side cross-sectional view of the second connector according to Embodiment 1, and is perspective one-side cross-sectional view taken along line F-F in FIG. 12.

FIG. 19 is a third perspective one-side cross-sectional view of the second connector according to Embodiment 1, and is perspective one-side cross-sectional view taken along line G-G in FIG. 12.

FIG. 20 is a fourth perspective one-side cross-sectional view of the second connector according to Embodiment 1, and is perspective one-side cross-sectional view taken along line H-H in FIG. 12.

FIG. 21 is a perspective view of a completed mating state of the first connector to the second connector according to Embodiment 1, where FIG. 21A is a perspective view of the first connector seen obliquely from above, and FIG. 21B is a perspective view of the first connector seen obliquely from below.

FIG. 22 is a plan view of the first connector in the completed mating state of the first connector and second connector according to Embodiment 1, as seen from above.

FIG. 23 includes three views of the completed mating state of the first connector to the second connector according to Embodiment 1, where FIG. 23A is a side view, FIG. 23B is a plan view of the second connector as seen from above, and FIG. 23C is a front view.

FIG. 24 is a side cross-sectional view illustrating the completed mating state of the first connector and the second connector according to Embodiment 1, and is a cross-sectional view taken along a line indicated by arrows J-J in FIG. 22.

FIG. 25 is a traverse cross-sectional view of the completed mating state of the first connector and the second connector according to Embodiment 1, where FIG. 25A is a cross-sectional view taken along a line indicated by arrows K-K in FIG. 22, FIG. 25B is a cross-sectional view taken along a line indicated by arrows L-L in FIG. 22, and FIG. 25C is a cross-sectional view taken along a line indicated by arrows M-M in FIG. 22.

FIG. 26 is a first perspective one-side cross-sectional view illustrating the completed mating state of the first connector and the second connector according to Embodiment 1, and is a cross-sectional view taken along line J-J in FIG. 22.

FIG. 27 is a second perspective one-side cross-sectional view illustrating the completed mating state of the first connector and the second connector according to Embodiment 1, and is a cross-sectional view taken along line K-K in FIG. 22.

FIG. 28 is a third perspective one-side cross-sectional view illustrating the completed mating state of the first connector and the second connector according to Embodiment 1, and is a cross-sectional view taken along line L-L in FIG. 22.

FIG. 29 is a fourth perspective one-side cross-sectional view illustrating the completed mating state of the first connector and the second connector according to Embodiment 1, and is a cross-sectional view taken along line M-M in FIG. 22.

FIG. 30 is a perspective view illustrating a first connector according to Embodiment 2, where FIG. 30A is a view seen obliquely from above, and FIG. 30B is a view seen obliquely from below.

FIG. 31 is a top view illustrating the first connector according to Embodiment 2.

FIG. 32 includes three views of a first connector according to Embodiment 2, where FIG. 32A is a side view, FIG. 32B is a bottom view, and FIG. 32C is a front view.

FIG. 33 is an exploded perspective view of the first connector according to Embodiment 2.

FIG. 34 is a side cross-sectional view of the first connector according to Embodiment 2, where FIG. 34A is a cross-sectional view taken along a line indicated by arrows A-A in FIG. 31 and FIG. 34B is a cross-sectional view taken along a line indicated by arrow N-N in FIG. 31.

FIG. 35 is a traverse cross-sectional view of the first connector according to Embodiment 2, where FIG. 35A is a cross-sectional view taken along a line indicated by arrows B-B in FIG. 31, FIG. 35B is a cross-sectional view taken along a line indicated by arrows C-C in FIG. 31, and FIG. 35C is a cross-sectional view taken along a line indicated by arrows D-D in FIG. 31.

FIG. 36 is a first perspective one-side cross-sectional view of the first connector according to Embodiment 2, and is a perspective one-side cross-sectional view taken along line A-A in FIG. 31.

FIG. 37 is a second perspective one-side cross-sectional view of the first connector according to Embodiment 2, and is perspective one-side cross-sectional view taken along line B-B in FIG. 31.

FIG. 38 is a third perspective one-side cross-sectional view of the first connector according to Embodiment 2, and is perspective one-side cross-sectional view taken along line C-C in FIG. 31.

FIG. 39 is a fourth perspective one-side cross-sectional view of the first connector according to Embodiment 2, and is perspective one-side cross-sectional view taken along line D-D in FIG. 31.

FIG. 40 is a fifth perspective one-side cross-sectional view of the first connector according to Embodiment 2, and is perspective one-side cross-sectional view taken along line N-N in FIG. 31.

FIG. 41 is a perspective view illustrating a second connector according to Embodiment 2, where FIG. 41A is a view seen obliquely from below, and FIG. 41B is a view seen obliquely from above.

FIG. 42 is a top view illustrating the second connector according to Embodiment 2.

FIG. 43 includes three views of the second connector according to Embodiment 2, where FIG. 43A is a side view, FIG. 43B is a bottom view, and FIG. 43C is a front view.

FIG. 44 is an exploded perspective view of the second connector according to Embodiment 2.

FIG. 45 is a side cross-sectional view of the second connector according to Embodiment 2, where FIG. 45A is a cross-sectional view taken along a line indicated by arrows E-E in FIG. 42 and FIG. 45B is a cross-sectional view taken along a line indicated by arrows P-P in FIG. 42.

FIG. 46 is a traverse cross-sectional view of the second connector according to Embodiment 2, where FIG. 46A is a cross-sectional view taken along a line indicated by arrows F-F in FIG. 42, FIG. 46B is a cross-sectional view taken along a line indicated by arrows G-G in FIG. 42, and FIG. 46C is a cross-sectional view taken along a line indicated by arrows H-H in FIG. 42.

FIG. 47 is a first perspective one-side cross-sectional view of the second connector according to Embodiment 2, and is perspective one-side cross-sectional view taken along line E-E in FIG. 42.

FIG. 48 is a second perspective one-side cross-sectional view of the second connector according to Embodiment 2, and is perspective one-side cross-sectional view taken along line F-F in FIG. 42.

FIG. 49 is a third perspective one-side cross-sectional view of the second connector according to Embodiment 2, and is perspective one-side cross-sectional view taken along line G-G in FIG. 42.

FIG. 50 is a fourth perspective one-side cross-sectional view of the second connector according to Embodiment 2, and is perspective one-side cross-sectional view taken along line H-H in FIG. 42.

FIG. 51 is a fifth perspective one-side cross-sectional view of the second connector according to Embodiment 2, and is perspective one-side cross-sectional view taken along line P-P in FIG. 42.

FIG. 52 is a perspective view of a completed mating state of the first connector to the second connector according to Embodiment 2, where FIG. 52A is a perspective view of the first connector seen obliquely from above, and FIG. 52B is a perspective view of the first connector seen obliquely from below.

FIG. 53 is a plan view of the first connector in the completed mating state of the first connector and second connector according to Embodiment 2, as seen from above.

FIG. 54 includes three views of the completed mating state of the first connector to the second connector according to Embodiment 2, where FIG. 54A is a side view, FIG. 54B is a plan view of the second connector as seen from above, and FIG. 54C is a front view.

FIG. 55 is a side cross-sectional view of the completed mating state between the first connector and second connector according to Embodiment 2, where FIG. 55A is a perspective cross-sectional view along a line indicated by arrows J-J in FIG. 53; and FIG. 55B is a perspective cross-sectional view along a line indicated by arrows R-R in FIG. 53.

FIG. 56 is a traverse cross-sectional view of the completed mating state of the first connector and the second connector according to Embodiment 2, where FIG. 56A is a cross-sectional view taken along a line indicated by arrows K-K in FIG. 53, FIG. 56B is a cross-sectional view taken along a line indicated by arrows L-L in FIG. 53, and FIG. 56C is a cross-sectional view taken along a line indicated by arrows M-M in FIG. 53.

FIG. 57 is a first perspective one-side cross-sectional view illustrating the completed mating state of the first connector and the second connector according to Embodiment 2, and is a cross-sectional view taken along line J-J in FIG. 53.

FIG. 58 is a second perspective one-side cross-sectional view illustrating the completed mating state of the first connector and the second connector according to Embodiment 2, and is a cross-sectional view taken along line K-K in FIG. 53.

FIG. 59 is a third perspective one-side cross-sectional view illustrating the completed mating state of the first connector and the second connector according to Embodiment 2, and is a cross-sectional view taken along line L-L in FIG. 53.

FIG. 60 is a fourth perspective one-side cross-sectional view illustrating the completed mating state of the first connector and the second connector according to Embodiment 2, and is a cross-sectional view taken along line M-M in FIG. 43.

FIG. 61 is a fifth perspective one-side cross-sectional view illustrating the completed mating state of the first connector and the second connector according to Embodiment 2, and is a cross-sectional view taken along line R-R in FIG. 43.

FIG. 62 is a perspective view illustrating a known connector.

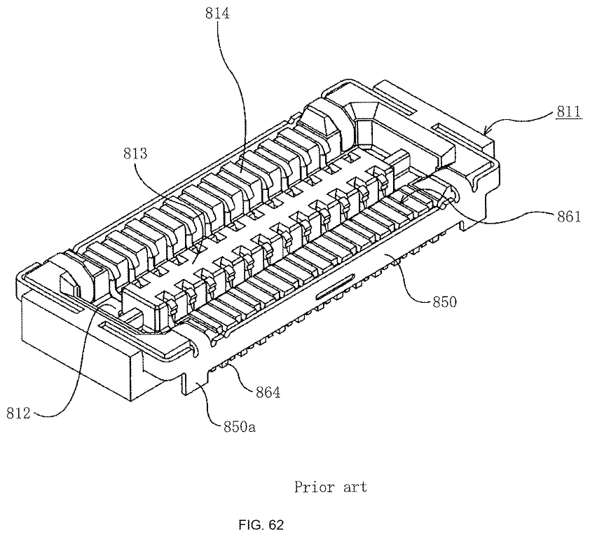

### DETAILED DESCRIPTION OF THE PREFERRED EMBODIMENTS

Embodiments will hereinafter be described in detail with reference to the drawings.

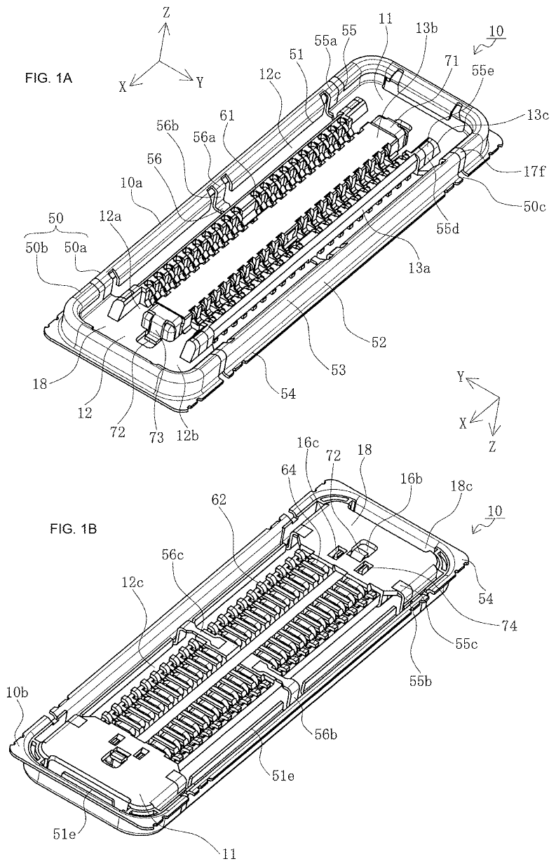

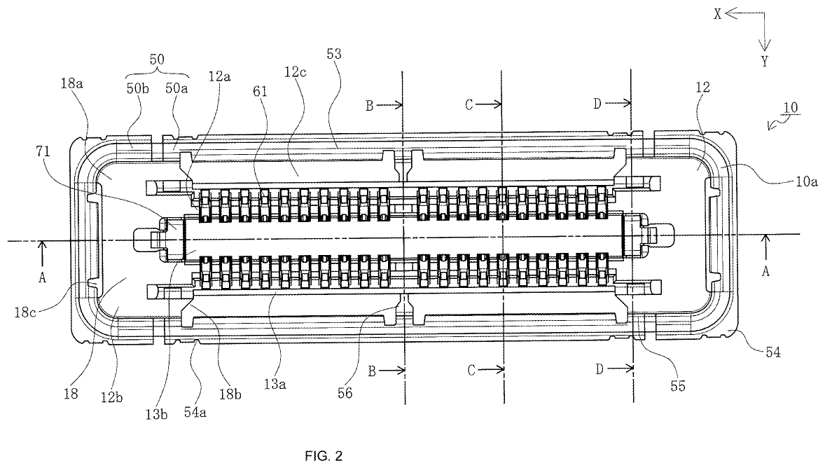

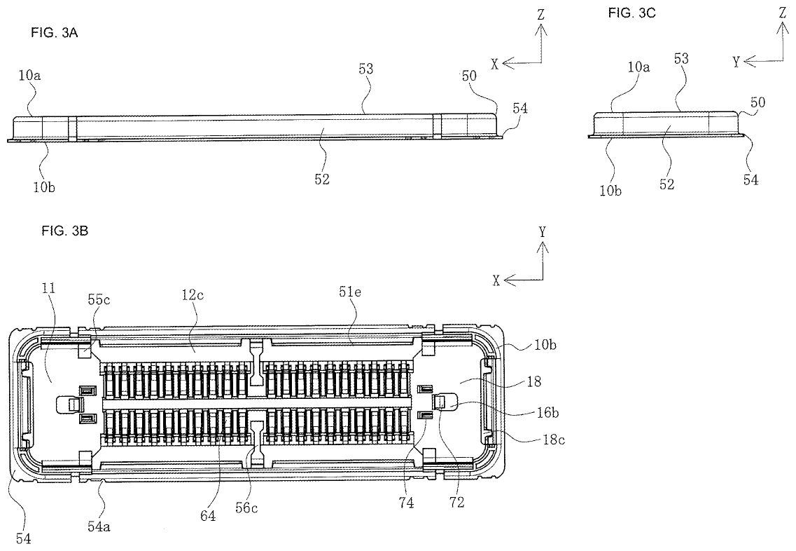

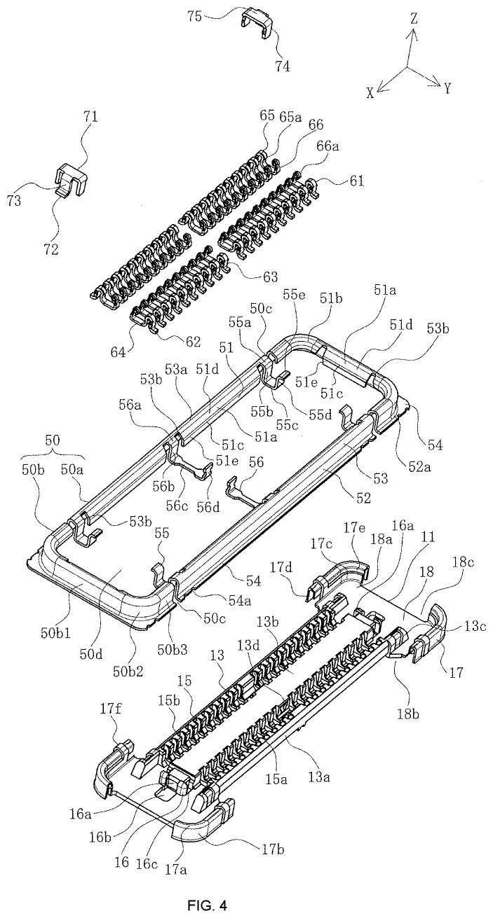

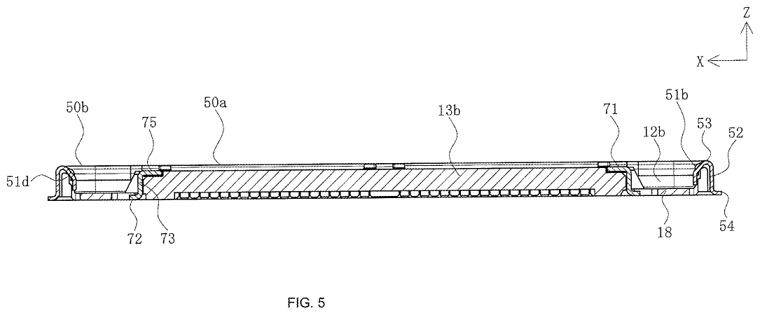

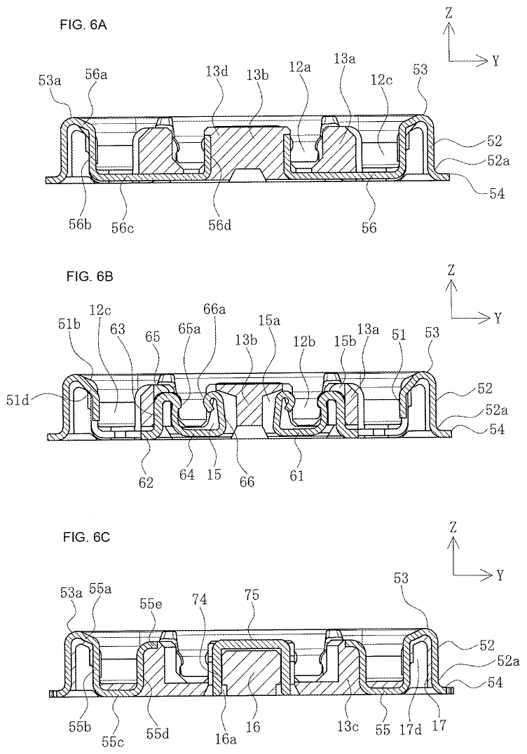

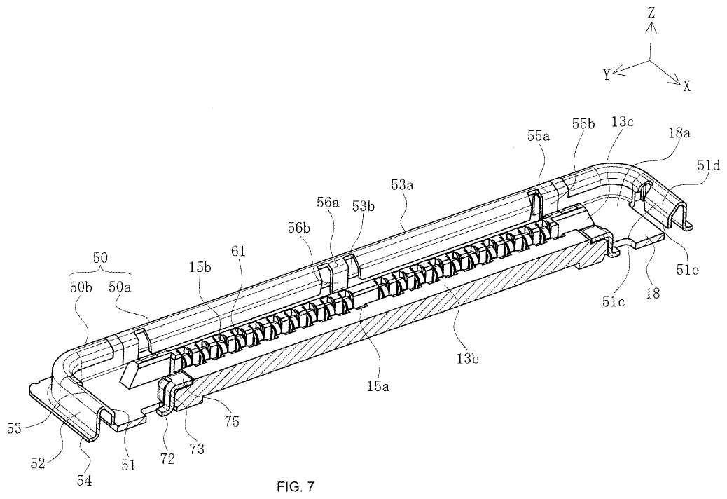

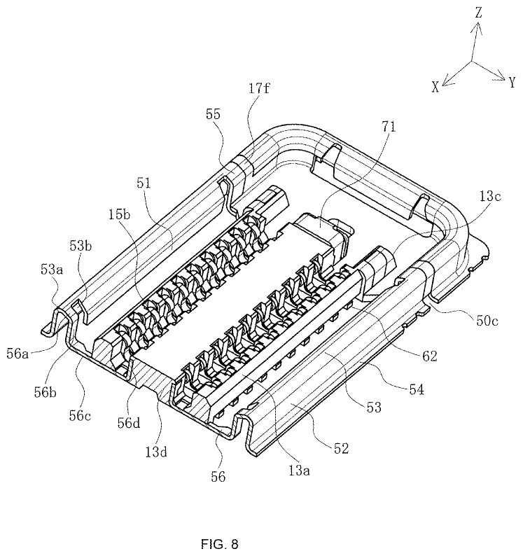

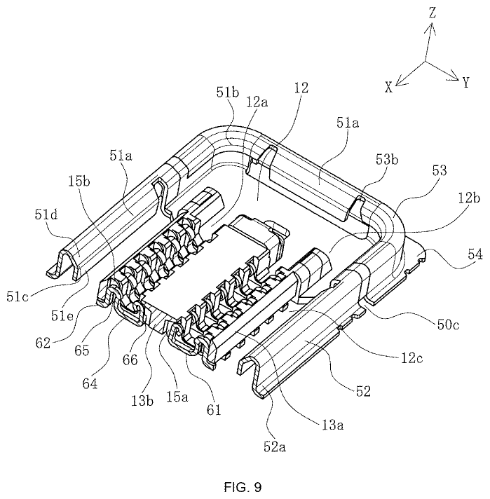

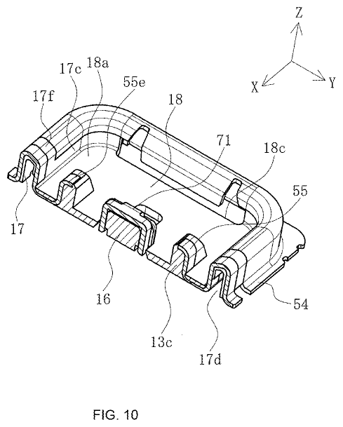

FIG. 1 is a perspective view of a first connector according to Embodiment 1, FIG. 2 is a top view of the first connector according to Embodiment 1, FIG. 3 includes three views of the first connector according to Embodiment 1, FIG. 4 is an exploded perspective view of the first connector according to Embodiment 1, FIG. 5 is a side cross-sectional view of the first connector according to Embodiment 1 and is a perspective one-side cross-sectional view taken along a line indicated by arrows A-A in FIG. 2, FIG. 6 is a traverse cross-sectional view of the first connector according to Embodiment 1, FIG. 7 is a first perspective one-side cross-sectional view of the first connector according to Embodiment 1 and is a perspective one-side cross-sectional view taken along line A-A in FIG. 2, FIG. 8 is a second perspective one-side cross-sectional view of the first connector according to Embodiment 1 and is a perspective one-side cross-sectional view taken along line B-B in FIG. 2, FIG. 9 is a third perspective one-side cross-sectional view of the first connector according to Embodiment 1 and is a perspective one-side cross-sectional view taken along line C-C in FIG. 2, and FIG. 10 is a fourth perspective one-side cross-sectional view of the first connector according to Embodiment 1 and is a perspective one-side cross-sectional view taken along line D-D in FIG. 2. In FIG. 1, (a) is an obliquely upward view, (b) is an obliquely downward view. In FIG. 3, (a) is a side view, (b) is a bottom view, and (c) is a front view. In FIG. 6, (a) is a cross-sectional view taken along a line indicated by arrows B-B in FIG. 2, (b) is a cross-sectional view taken along a line indicated by arrows C-C in FIG. 2, (c) is a cross-sectional view taken along a line indicated by arrows D-D in FIG. 2

In the drawings, a first connector 10 is a connector of the present Embodiment, and is one of a pair of board-to-board connectors that are a connector pair. The first connector 10 is a surface mounting type receptacle connector mounted on a surface of a first substrate that is a substrate (not illustrated) serving as a mounting member and is mated together with a second connector 101 described below. Furthermore, the second connector 101 is the other one of the pair of board-to-board connectors and is a surface mounting type plug connector mounted on a surface of a second substrate (not illustrated) serving as a mounting member. Each of the first connector 10 and the second connector 101 serves as the mating connector, of a pair of board-to-board connectors, for the other.

Note that the first connector 10 and the second connector 101 of the connector pair according to the present Embodiment are preferably used to electrically connect the first substrate to the second substrate but can also be used to electrically connect other members. For example, the first board and the second board are each a printed circuit board, a flexible flat cable (FFC), a flexible circuit board (FPC), or the like as used in electronic devices or the like, but may be any type of board.

Furthermore, in the present Embodiment, expressions indicating direction such as up, down, left, right, front, rear, and the like used to describe a configuration and operation of each part of the connector pair first connector 10 and the second connector 101 are relative rather than absolute and are appropriate when each part of the first connector 10 and the second connector 101 are in positions illustrated in the drawings. However, these directions should be interpreted as changing in accordance with a change in position when the position thereof is changed.

Furthermore, the first connector 10 has: a first shield 50 as a shielding member, which is a receptacle shield formed by performing punching, drawing, or the like on a conductive metal plate; and a first housing 11 as a connector main body integrally formed by an insulating material such as a synthetic resin or the like. The first housing 11 has a flat bottom plate 18, first protruding parts 13 that are three protruding walls of an elongated shape standing upward from an upper surface of the bottom plate 18, and corner parts 17 protruding upward from four corners of the bottom plate 18.

The corner part 17 is a main portion that is connected to the first shield 50 when the first shield 50 is integrated with the first housing 11 by over-molding or insert molding. Specifically, the first housing 11 is molded by filling a cavity of a mold in which the first shield 50 is internally set in advance, with an insulating material such as synthetic resin or the like, and is integrally connected to the first shield 50 at the corner parts 17 and other portions. Therefore, the first housing 11 and the first shield 50 do not exist separately, but in FIG. 4, for convenience of description, the first housing 11 and the first shield 50 are illustrated as if they exist separately.

As illustrated in FIG. 4, each of the corner parts 17 is shaped like one of four sections of a cylindrical wall with an elliptical cylindrical cross-sectional shape, and includes: an upper wall part 17a having an arc shaped portion with a central angle of approximately 90 degrees in plan view and a linear portion extending in the longitudinal direction (X-axis direction) of the first connector 10; an outer wall part 17b extending downward (in the Z-axis negative direction) from the outer edge of the upper wall part 17a; and an inner wall part 17c extending downward from the inner edge of the upper wall part 17a. The interior of the corner part 17 is defined by the upper wall part 17a, the outer wall part 17b, and the inner wall part 17c, and serves as a cavity part 17d that is a space whose lower end is open. Furthermore, the inner wall part 17c has a shield housing part 17e recessed to store the inner wall 51 in the vicinity of the corner part 50 of the first shield 50. Furthermore, the lower end of the inner wall part 17c is connected to the tip end of the connecting part 18a extending outward at each of the four corners of the bottom plate 18.

The corner part 17 further includes a separation protruding part 17f which is continuous over the outer circumferential surfaces of the upper wall part 17a, the outer wall part 17b, and the inner wall part 17c. The separation protruding part 17f is a protruding part formed at a position corresponding to a cutout part 50c that separates a long side part 50a and a short side part 50b of the first shield 50. In each corner part 17, a portion more on the outer side than the separation protruding part 17f in the longitudinal direction of the first connector 10 is integrally connected to the short side part 50b, and a portion more on the inner side than the separation protruding part 17f in the longitudinal direction of the first connector 10 is integrally connected to the long side part 50a.

The first protruding part 13 is an essentially rectangular-shaped member extending in the longitudinal direction (X-axis direction) of the first connector 10, and includes a pair of outer side protruding parts 13a extending in the longitudinal direction of the first connector 10 on both sides in the width direction (Y-axis direction) of the first connector 10, a pair of inner side protruding parts 13b extending in the longitudinal direction of the first connector 10 at the center in the width direction, and an outer end protruding part 13c connected to each of both ends of the outer side protruding part 13a in the longitudinal direction. Furthermore, a pair of inner recessed groove parts 12a, which are recessed parts extending in the longitudinal direction of the first connector 10, are formed as a portion of the first recessed part 12 between the outer side protruding parts 13a on both sides to the left and right of the inner side protruding part 13b.

Here, a first signal terminal housing cavity 15 is formed from both left and right side surfaces of the inner side protruding part 13b, along the bottom surface of the inner recessed groove part 12a, and to the side surface of the outer side protruding part 13a. In the illustrated example, the first signal terminal housing cavities 15 pass through the bottom plate 18 in the plate-thickness direction (Z-axis direction). Note that, of the first signal terminal housing cavities 15, recessed groove parts formed on both side surfaces on the left and right of the inner side protruding part 13b are referred to as a first signal terminal housing inner side cavity 15a, and recessed groove parts formed on side surfaces facing the inner side protruding part 13b at the outer side protruding part 13a are referred to as a first signal terminal housing outer side cavity 15b.

The plurality of first signal terminal housing cavities 15 are arranged to form rows, extending in the longitudinal direction, at a predetermined pitch (for example, 0.35 [mm]). Note that the pitch and the number of the first signal terminal housing cavities 15 can be changed as appropriate. A plurality of first terminals 61, which are terminals housed in the respective first signal terminal housing cavities 15 and attached to the first housing 11, are also provided at a similar pitch on both the sides of the inner side protruding parts 13b. Thus, the plurality of first terminals 61 are arranged along each of inner recessed groove part 12a, to be arranged to form a row extending in the longitudinal direction of the first connector 10. In the example illustrated, the number of the first terminals 61 on each of the left and right sides is 20, and the number of the poles of the first connector 10 is 40. However, the number of the first terminals 61 may be increased, for example, and the number of poles of the first connector 10 may be 70 or more.

A side recessed part 18b is formed in the bottom plate 18 on the outer side of the first protruding part 13 in the width direction of the first connector 10, and as a result, the bottom plate 18 has a smaller dimension in the width direction of the first connector 10, or in other words, is formed to a narrow width. In addition, end recessed parts 18c are formed at both ends of the bottom plate 18 in the longitudinal direction of the first connector 10, and therefore, the bottom plate 18 has a small dimension in the longitudinal direction of the first connector 10, or in other words, is formed to be short.

Further, metal fitting attachment parts 16 to which first metal fittings 71 as power metal fittings are attached are connected to both ends of the inner side protruding parts 13b in the longitudinal direction. A metal fitting accommodating groove 16a for accommodating the first metal fitting 71 is formed on a side surface of the metal fitting attachment part 16. A first metal fitting connection opening 16b that is an opening formed through the bottom plate 18 in the plate-thickness direction is formed on the outer side of the metal fitting attachment part 16 in the longitudinal direction of the first connector 10. First metal fitting connection slits 16c that are openings formed through the bottom plate 18 in the plate-thickness direction are formed on the outer sides (left and right) of the metal fitting attachment part 16 in the width direction of the first connector 10. A tail part 72 of the first metal fitting 71 is accommodated in the first metal fitting connection opening 16b, and the lower end of a side plate part 74 of the first metal fitting 71 is accommodated in the first metal fitting connection slit 16c.

The first shield 50 is a member formed by performing punching, drawing, or the like on a conductive metal plate, and as illustrated in FIG. 2, is an essentially rectangular frame shaped member when viewed from above, in other words, in plan view, which surrounds, that is, encloses an entire circumference of the first housing 11. It should be noted that, in the present embodiment, “surround” or “enclose” means not only continuously surrounding the entire circumference of an object such as the first housing 11 without any gap, but also intermittently surrounding the entire circumference of the object with some gaps, and further means continuously surrounding the object without a gap or intermittently surrounding the object with some gaps, over more than half of the circumference of the object.

The first shield 50 includes a plurality of (in pair in the example illustrated in the drawings) the long side parts 50a as side shields which are first shielding members extending linearly in the longitudinal direction of the first connector 10, and a plurality of (in pair in the example shown in the drawings) short side parts 50b as end part shields which are second shielding members. The short side parts 50b enclosing both ends of the first housing 11 in the longitudinal direction include: a first part 50b1 that is a part linearly extending in the width direction of the first connector 10; second parts 50b2 connected to both ends of the first part 50b1 and have an arc shape with a central angle of approximately 90 degrees in plan view, and a third part 50b3 that are connected to the second parts 50b2 and linearly extends in the longitudinal direction of the first connector 10.

The long side part 50a and the short side part 50b are separated from each other by the cutout part 50c that is a narrow space between the long side part 50a and the third part 50b3 of the short side part 50b. Alternatively, the long side part 50a and the short side part 50b may be integrated with the cutout part 50c omitted if necessary. The long side part 50a and the short side part 50b will be collectively described as the first shield 50. Note that an enclosed space surrounded on the circumference by the first shield 50 is a housing part 50d in which the second connector 101, which is a plug connector, is inserted and accommodated.

Furthermore, the first shield 50 includes: an outer wall 52 that serves as a shielding plate; an inner wall 51 essentially parallel to the outer wall 52 on an inner side of the outer wall 52; and a coupling part 53 that connects an upper end of the outer wall 52 with an upper end of the inner wall 51. While the outer wall 52 is a wall continuous over the entire circumferences of the long side part 50a and the short side part 50b except for the cutout part 50c, the inner walls 51 are divided into a plurality of parts not only by the cutout part 50c but also by a slit part 53b formed in the long side part 50a and the short side part 50b.

In each short side part 50b, the pair of slit parts 53b are formed in the first part 50b1, and a part whose both ends are defined by the pair of slit parts 53b is referred to as the mating spring part 51a. The remaining portion in each short side part 50b is referred to as the mating positioning part 51b. In each long side part 50a, the slit part 53b is formed in the vicinity of each of both ends in the longitudinal direction, and the pair of slit parts 53b close to each other are formed at any parts between the slit parts 53b in the vicinity of both ends in the longitudinal direction. Two parts having both ends defined by the two slit parts 53b are each referred to as the mating spring part 51a.

The mating spring part 51a is a portion extending linearly within the range of each long side part 50a and within the range of each short side part 50b, and when the first connector 10 and the second connector 101 are in a mated state, the mating spring part elastically contacts the outer wall 152 of the second shield 150 of the second connector 101 described below and functions as a contacting part that maintains the conductive state between the first shield 50 and the second shield 150. Furthermore, the mating positioning part 51b is a portion where portions of the third part 50b3 and the first part 50b1 that are linear are connected to both ends of the second parts 50b2 which are curved corner parts, and when the first connector 10 and the second connector 101 are mated, guides the second connector 101 that is inserted into the housing part 50d. Specifically, the second connector 101 is inserted into the housing part 50d while the outer wall 152 of the second shield 150 is in contact with the mating positioning part 51b, thereby positioning is performed between the second connector 101 and the first connector 10.

Furthermore, the upper end of the mating spring part 51a is connected to an upper end part 53a of the coupling part 53 that is an upper end part of the first shield 50, and contains an oblique surface part 51d that extends obliquely downward to the inside of the housing part 50d, an inner wall lower part 51e that extends substantially vertically downward from the lower end of the oblique surface part 51d, and an engagement corner part 51c that is a corner part forming the boundary between the oblique surface part 51d and the inner wall lower part 51e. Furthermore, the engagement corner part 51c is a portion that engages with an engagement protruding part 152c described below formed on an outer wall 152 of a second shield 150 of the second connector 101 when the first connector 10 and the second connector 101 are in a mated state and extends linearly in the longitudinal direction or width direction of the first connector 10. The mating spring parts 51a are not connected to the first housing 11, but are relatively flexible and can be elastically deformed in a direction of approaching or separating from the outer wall 52, since both ends are separated from another portion by the slit part 53b.

The mating positioning part 51b is integrated with the corner parts 17 of the first housing 11. The vicinity of the upper end of the mating positioning part 51b is a gradual oblique surface part that slopes gradually downward toward the inside of the housing part 50d from the upper end part 53a of the coupling part 53. Therefore, as illustrated in FIGS. 5 and 6, when viewed in the longitudinal direction and width direction of the first connector 10, the oblique angle of the gradual oblique surface part, or in other words, the taper angle, is more gentle than the taper angle of the mating spring part 51a oblique surface part 51d, and when the first connector 10 and the second connector 101 are mated together, the gradual oblique surface of the mating positioning part 51b contacts the second connector 101 that is inserted into the housing part 50d, and subsequently, the oblique surface part 51d of the mating spring part 51a makes contact. Thereby, the damage to the mating spring part 51a can be reduced when the first connector 10 and the second connector 101 are mated.

The second parts 50b2 and the third part 50b3 of the short side part 50b function as fixing parts that fix the first shield 50 to the first housing 11, and achieve the fixing by integral connection between the short side part 50b and the vicinity of both ends of the first housing 11 in the longitudinal direction with no gap in between. Specifically, the second parts 50b2 and the third part 50b3 of the short side part 50b are portions that are connected to the first housing 11 when the first shield 50 is integrated with the first housing 11 by over-molding or insert molding, and is a portion that is integrated with the corner part 17. Furthermore, the inner wall 51 at the second parts 50b2 and the third part 50b3 is housed within the shield housing part 17e formed in the inner wall part 17c at the corner part 17. This ensures that the short side part 50b and the first housing 11 are firmly integrated and cannot be separated. The surfaces of the inner walls 51 in the second part 50b2 and the third part 50b3 are preferably flush with the surfaces of the inner walls 17c of the corner parts 17. Thus, the second connector 101 can be stably guided to mate with the first connector 10.

In each long side part 50a, an end joint part 55 for fixedly connecting the long side part 50a and the first housing 11 is formed between both ends in the longitudinal direction and the slit part 53b formed in the vicinity of both ends. The end joint part 55 functions as a fixing part for fixing the first shield 50 to the first housing 11, and integrally connects and fixes both ends of the long side part 50a in the longitudinal direction and the vicinity of both ends of the first housing 11 in the longitudinal direction with no gap therebetween. To be specific, the end joint part 55 is a member formed by bending an elongated strip whose base end is connected to the long side part 50a and whose tip end is embedded in the outer end protruding part 13c. Specifically, the end joint part 55 includes: a base end part 55a that has an upper end connected to the upper end part 53a of the coupling part 53 that is the upper end part of the first shield 50; a first vertical part 55b that extends substantially vertically downward from the lower end of the base end part 55a; a first horizontal part 55c that extends substantially horizontally from the lower end of the first vertical part 55b toward the center of the first connector 10 in the width direction (Y-axis direction); a second vertical part 55d that extends substantially vertically upward from the tip end of the first horizontal part 55c; and a second horizontal part 55e that extends substantially horizontally from the upper end of the second vertical part 55d toward the center of the first connector 10 in the width direction.

When the first shield 50 is integrated with the first housing 11 by over-molding or insert molding, the base end part 55a and an approximately upper half of the first vertical part 55b are integrated with portion of the corner part 17 that is more on the inner side than the separation protruding part 17f in the longitudinal direction of the first connector 10, to be exposed on the surfaces of the upper wall part 17a and the inner wall part 17c. The first horizontal part 55c is mostly integrated with the connecting part 18a of the bottom plate 18 to be exposed on the lower surface of the connecting part 18a. The second vertical part 55d is mostly integrated with the outer end protruding part 13c connected to the connecting part 18a to be exposed on the side surface of the outer end protruding part 13c. The second horizontal part 55e is integrated with the outer end protruding part 13c to be exposed on the upper surface of the outer end protruding part 13c. This ensures that the long side part 50a and the first housing 11 are firmly integrated and cannot be separated.

In each long side part 50a, an intermediate joint part 56 as a joint part connecting the long side part 50a and the first housing 11 is formed between the pair of slit parts 53b close to each other at any portion between the end joint parts 55 at both ends in the longitudinal direction. In the example illustrated in the drawings, one intermediate joint part 56 is formed at the center of each long side part 50a in the longitudinal direction, but the intermediate joint part 56 is not necessarily formed at the center of the long side part 50a in the longitudinal direction, and may be formed at any position of the long side part 50a in the longitudinal direction, or two or more intermediate joint parts 56 may be formed. Here, for convenience of explanation, only a case where one intermediate joint part 56 is formed at the center of each long side part 50a in the longitudinal direction will be described.

The intermediate joint part 56 is a member formed by bending an elongated strip whose base end is connected to the long side part 50a and whose tip end is embedded in an intermediate joint holding part 13d of the inner side protruding parts 13b. The first signal terminal housing cavity 15 is not formed at a portion of the first housing 11 corresponding to the intermediate joint part 56. The intermediate joint part 56 extends from the upper end of the outer wall 52 toward a mounting surface 10b of the first connector 10, and then extends toward the first housing 11. The tip end of the intermediate joint part 56 is fixed to the first housing 11 between the first terminals 61 adjacent to each other in the longitudinal direction of the first connector 10. Specifically, the intermediate joint part 56 includes: a base end part 56a that has an upper end connected to the upper end part 53a of the coupling part 53 that is the upper end part of the first shield 50; a first vertical part 56b that extends substantially vertically downward from the lower end of the base end part 56a; a first horizontal part 56c that extends substantially horizontally from the lower end of the first vertical part 56b toward the center of the first connector 10 in the width direction; a second vertical part 56d that extends substantially vertically upward from the tip end of the first horizontal part 56c.

When the first shield 50 is integrated with the first housing 11 by over-molding or insert molding, approximately half of the first horizontal part 56c is integrated with the bottom plate 18 to be exposed on the lower surface of the inner side protruding parts 13b, and the second vertical part 56d is mostly integrated with the intermediate joint holding part 13d to be exposed on the side surface of the intermediate joint holding part 13d. Thus, the long side part 50a and the first housing 11 are also integrated with each other at an intermediate portion in the longitudinal direction, and thus have the orientation and the shape stably maintained. Part of the intermediate joint part 56 can be electrically connected to the first substrate. Specifically, the first horizontal part 56c is preferably electrically connected to a connection pad on the surface of the first substrate.

A flange part 54 serving as an outwardly extending flat part is connected to the lower end of the outer wall 52 through the bent part 52a bent at an angle of approximately 90 degrees. The bent part 52a and the flange part 54 are connected to the lower end of the outer wall 52 in a continuous manner around the entire circumference, except for the cutout part 50c. Note that in the example illustrated in the drawings, a small notch 54a is formed in a plurality of locations on the flange part 54, but the notch 54a can be omitted as appropriate.

The flange part 54 functions as a substrate connecting part, a lower surface of which is parallel to the surface of the first substrate and is a portion connected by soldering or the like to the connection pad on the surface. The connection pad is typically connected to a ground line. Furthermore, the outer wall 52, in addition to being a continuous wall itself, is connected to a portion where an upper end thereof is continuous at the coupling part 53, which is a portion extending in a direction orthogonal to the outer wall 52 in a cross section as illustrated in FIGS. 5 and 6 and is connected to a member where a lower end thereof is continuous as with the flange part 54, which is a member extending in a direction orthogonal to the outer wall 52 in the cross section as illustrated in FIGS. 5 and 6. Therefore, the outer wall 52 is relatively rigid and resistant to deformation.

Furthermore, when the first housing 11 is connected to the first shield 50 in the stowing part 50d, a first recess 12 that mates with the second connector 101 is formed in the stowing part 50d, which is a recess with a circumference surrounded by the inner wall 51 and a lower portion is demarcated by the bottom plate 18. Furthermore, as described above, the inner recessed groove parts 12a which are long narrow recessed parts extending in the longitudinal direction of the first connector 10 are formed as a portion of the first recessed part 12, between the outer side protruding parts 13a on both sides to the left and right of the inner side protruding part 13b. Furthermore, mating recesses 12b are formed at two outer ends of the first protruding part 13 with regard to the longitudinal direction of the first connector 10 as a portion of the first recessed part 12.

Furthermore, a side space 12c, which is an elongated recessed space extending in the longitudinal direction of the first connector 10, is formed between each outer side protruding part 13a and the outer wall 52 of the long side part 50a. The side space 12c is formed in a range corresponding to at least the row of the first terminals 61 in the longitudinal direction of the first connector 10.

Furthermore, the first terminal 61 is a member integrally formed by punching, bending, or the like on a conductive metal plate, and is provided with the retained part 63, the tail part 62 serving as a substrate connecting part connected to a lower end of the retained part 63, an outer side connecting part 65 connected to an upper end of the retained part 63, and a lower side connecting part 64 connected to a lower end of the outer side connecting part 65 having an essentially U-shaped side surface shape. The contacting part 65a curved so as to swell inward in the width direction of the first connector 10 is formed in the vicinity of the lower end of the outer side connecting part 65. Furthermore, the first terminal 61 is further provided with an inner side connecting part 66 connected to a tip end of the lower side connecting part 64. The inner side connecting part 66 is bent and connected to the lower side connecting part 64, and extends upwardly (Z-axis positive direction). A contacting part 66a curved so as to bulge outwardly in the width direction of the first connector 10 is formed in the vicinity of an upper end of the inner side connecting part 66. The contacting part 66a is similar to the contacting part 65a of the outer side connecting part 65, and is a portion that contacts the second terminal 161 provided in the second connector 101 as described below. In other words, the first terminal 61 in the present Embodiment is provided with the contacting part 65a of the outer side connecting part 65 and the contacting part 66a of the inner side connecting part 66, which face each other, and is configured to make two-point contact with the second terminal 161. When the first terminal 61 is mounted in the first housing 11, the contacting part 65a of the outer side connecting part 65 and the contacting part 66a of the inner side connecting part 66 protrude into the inner recessed groove part 12a so as to be facing each other.

Furthermore, the first terminal 61 is press-fitted into the first signal terminal housing cavity 15 from a mounting surface 10b side, which is a lower surface (Z-axis negative direction surface) of the first connector 10, and is fixed to the first housing 11 based on the retained part 63 being sandwiched from two sides by the inner side surfaces of the first signal terminal housing outer side cavity 15b. Note that the first terminal 61 is not required to be attached to the first housing 11 by press fitting, but may be integrated with the first housing 11 by overmolding or insert molding. Here, for convenience of description, a case in which the retained part 63 is pressed into and retained by the first signal terminal housing outer side cavity 15b will be described.

The tail part 62 is bent and connected to the retained part 63, extends in a left-right direction (Y-axis direction), in other words, outward in the width direction of the first connector 10, and is connected to the connection pad connected to a conductive trace of the first substrate by soldering or the like. The conductive trace is typically a signal line.

The first metal fitting 71 is a member integrally formed by performing a process, such as punching or bending, on a conductive metal plate, and includes: a top plate part 75; the pair of side plate parts 74 extending downward (Z-axis negative direction) from both ends of the top plate part 75 in the lateral direction; a coupling piece 73 extending downward from an end of the top plate part 75 on the outer side in the longitudinal direction of the first connector 10; and the tail part 72 that is a substrate connecting part connected to the lower end of the coupling piece 73.

The first metal fittings 71 are attached to the metal fitting attachment parts 16, with the coupling piece 73 and the side plate part 74 press fitted in the metal fitting accommodating groove 16a, from a mating surface 10a side that is the upper surface (Z-axis positive direction surface) of the first connector 10. Note that the first metal fitting 71 is not necessarily attached to the first housing 11 by press fitting but may be integrated with the first housing 11 by over-molding or insert molding. Herein, for convenience of description, a case in which the coupling piece 73 and the side plate part 74 are pressed into and retained by the metal fitting accommodating groove 16a will be described.

The tail part 72 is bent and connected to the coupling piece 73, extends outward in the longitudinal direction of the first connector 10, accommodated in the first metal fitting connection opening 16b, and is connected to the connection pad connected to a conductive trace of the first substrate by soldering or the like. The lower end of the side plate part 74 is accommodated in the first metal fitting connection slit 16c and is connected to the connection pad coupled to the conductive trace of the first substrate by soldering or the like. It should be noted that the conductive traces are described as power lines, i.e., power lines, which carry power. The outer side surface of the side plate part 74 functions as a contacting part and is a portion to be in contact with a second metal fitting 171, described below, of the second connector 101.

The first metal fitting 71 functions not only as a power metal fitting for transmitting power but also as a protective metal fitting for protecting both ends of the inner side protruding parts 13b in the longitudinal direction.

Furthermore, the first connector 10 is placed on the surface of the first substrate with solder applied to the mounting surface 10b side of the first shield 50, the first terminals 61, the first metal fittings 71, and the like and is fixed and mounted on the surface of the first substrate by heating and melting the solder using a heating furnace or the like. The solder is applied by applying a solder sheet, applying a solder paste, transferring a cream solder, dipping, jet soldering, or the like. Note that means for connecting the first shield 50, the first terminal 61, the first metal fittings 71, and the like to the connection pad of the first substrate and the like are not necessarily limited to soldering and may be, for example, conductive adhesive or the like. Still, a case where a solder sheet is used will be described herein.

Specifically, the solder is applied to the lower surface of a flange part 54 corresponding to the long side part 50a and the short side part 50b of the first shield 50, and is also applied to each of the lower surfaces of the tail part 62 of the first terminal 61 and the lower surfaces of the tail part 72 and the side plate part 74 of the first metal fittings 71. Preferably, the solder is also applied to the lower surface of the first horizontal part 55c of the end joint part 55 and the lower surface of the first horizontal part 56c of the intermediate joint part 56.

When the solder applied in this manner is heated and melted, and the first connector 10 is mounted on the surface of the first substrate, the bent part 52a and the flange part 54, which are continuously connected to the lower end of the outer wall 52 that is continuous over the long side part 50a and the short side part 50b of the first shield 50, are connected to the connection pads on the surface of the first substrate without a gap. Therefore, the strength of the long side part 50a and the short side part 50b of the first shield 50 connected to the connection pads on the surface of the first substrate is high, and consequently, the strength of the entire first connector 10 with an outer circumference surrounded by the long side part 50a and the short side part 50b is high. Furthermore, an electromagnetic shielding effect exerted by the long side part 50a and the short side part 50b, which is connected without a gap to the connection pads on the surface of the first substrate, is very high, and the first connector 10 with an outer circumference surrounded by the long side part 50a and the short side part 50b is very effectively electromagnetically shielded.

In particular, the smoothness of the lower surface of the flange part 54 is high. Thus, the strength of the long side part 50a and the short side part 50b connected to the connection pads on the surface of the first substrate can be made extremely high. Moreover, since no gap is created between the connection pads on the surface of the first substrate, the electromagnetic shielding effect can also be made extremely high.

The long side part 50a that extends long in the longitudinal direction of the first connector 10 has both ends in the longitudinal direction integrated with the portions of the corner parts 17 more on the inner side than the separation protruding part 17f in the longitudinal direction of the first connector 10. Furthermore, each of the end joint parts 55 is integrated with the connecting part 18a of the first housing 11, the corner parts 17 connected to the connecting part 18a, and the outer end protruding part 13c. Furthermore, an intermediate portion in the longitudinal direction including the tip end of the intermediate joint part 56 is integrated with the bottom plate 18 and the inner side protruding parts 13b in an intermediate part in the longitudinal direction of the first housing 11. Thus, the decrease in the flatness of the flange part 54 in the long side part 50a due to warpage of the first housing 11 which is an elongated member made of an insulating material such as synthetic resin is reliably prevented. Furthermore, the connection between the flange part 54 and the bent part 52a of the long side part 50a and the connection pads on the surface of the first substrate is reliably maintained. When the lower surface of the first horizontal part 56c of the intermediate joint part 56 is also soldered onto the connection pads on the surface of the first substrate, the decrease in the flatness of the flange part 54 of the long side part 50a is more reliably prevented.

Next, the configuration of the second connector 101 will be described.

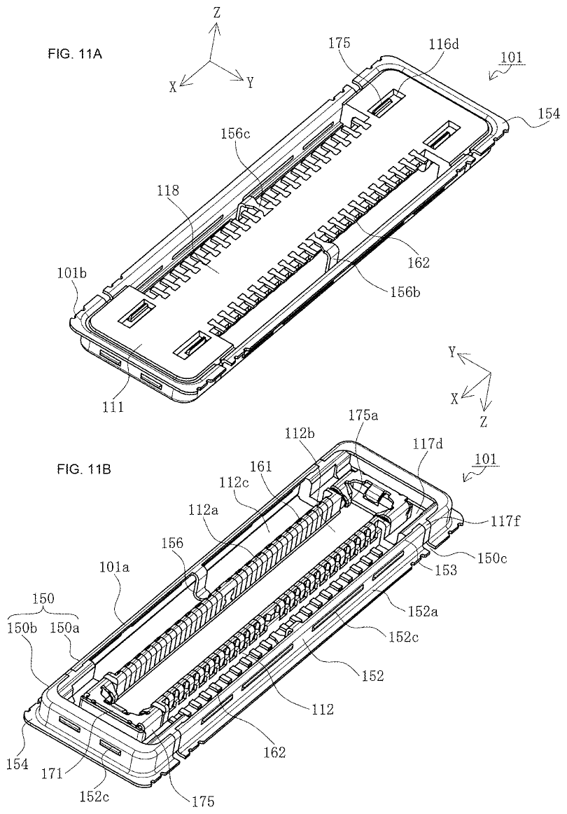

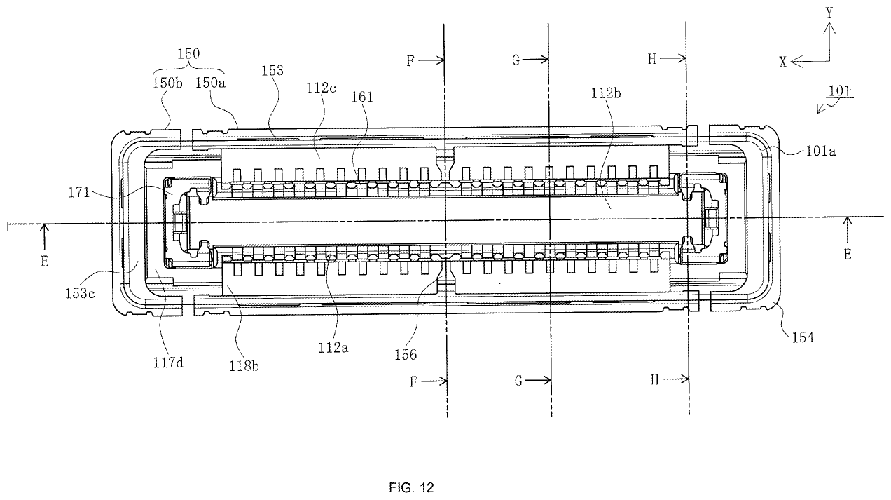

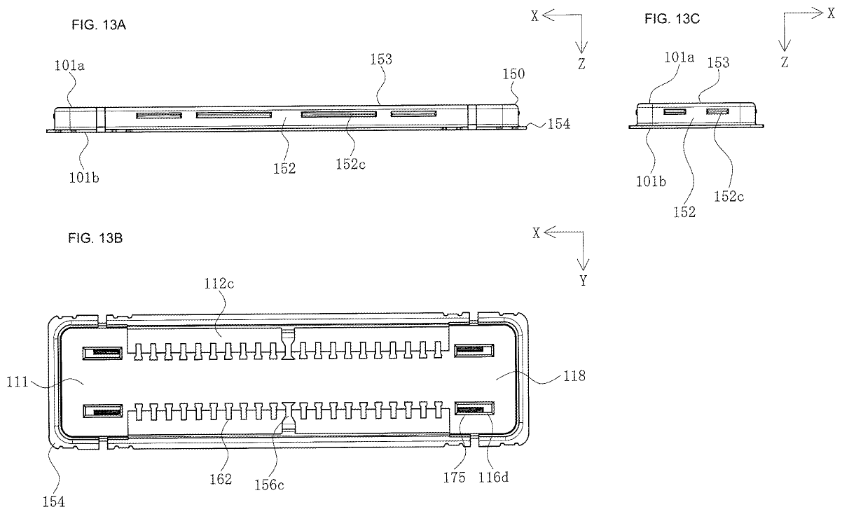

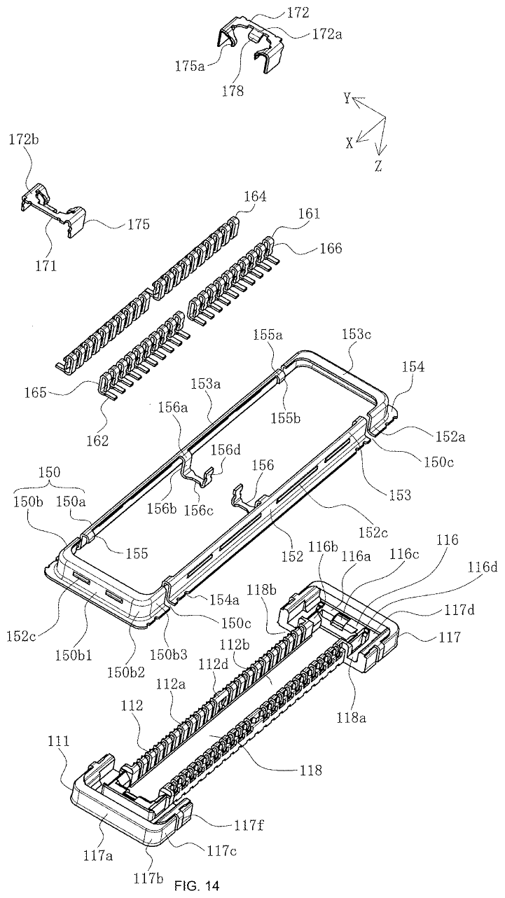

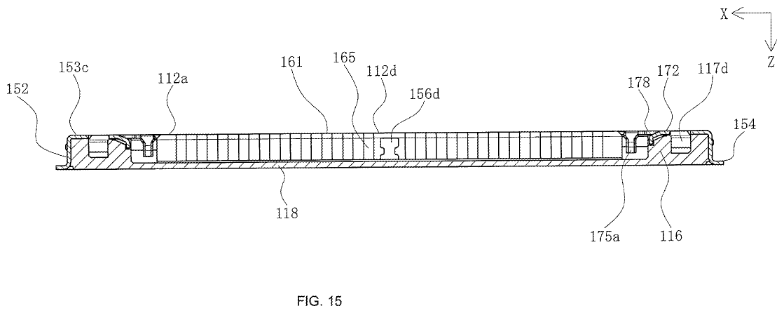

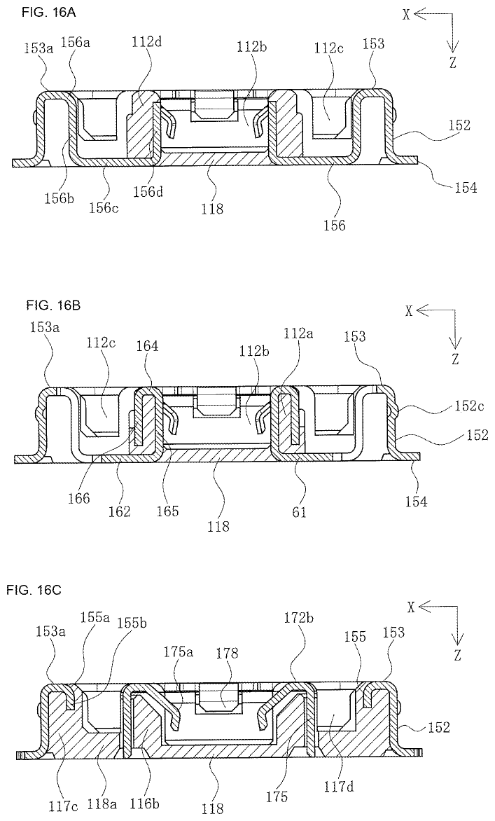

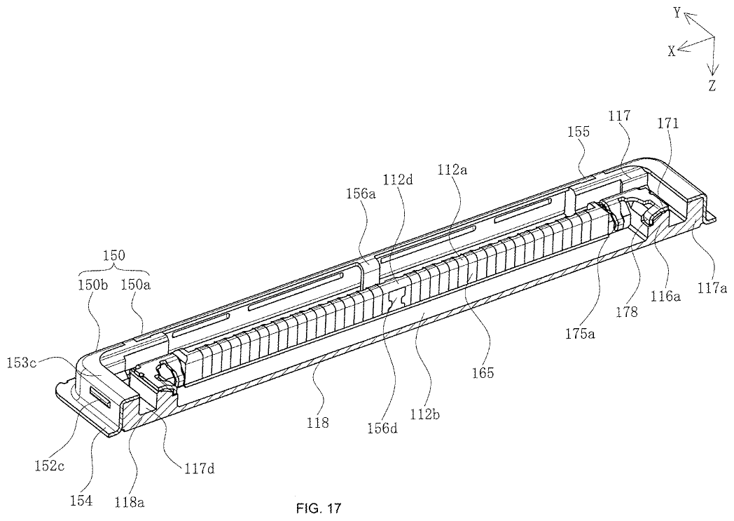

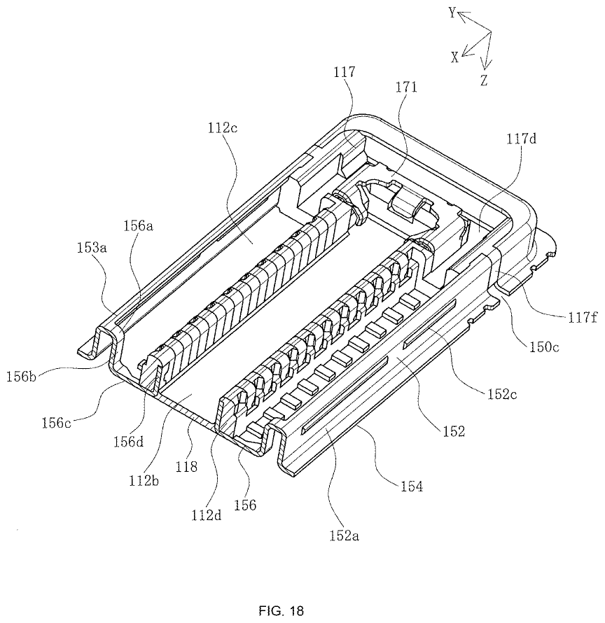

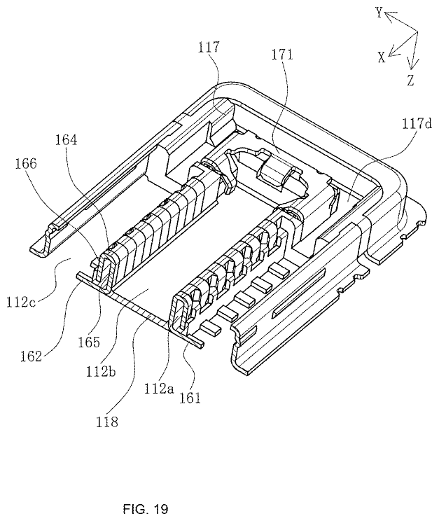

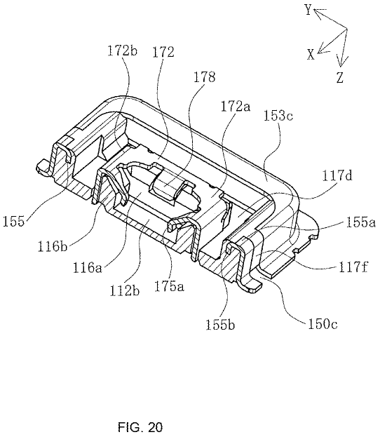

FIG. 11 is a perspective view of a second connector according to Embodiment 1, FIG. 12 is a top view of the second connector according to Embodiment 1, FIG. 13 includes three views of the second connector according to Embodiment 1, FIG. 14 is an exploded perspective view of the second connector according to Embodiment 1, FIG. 15 is a side cross-sectional view of the second connector according to Embodiment 1 and is a perspective one-side cross-sectional view taken along a line indicated by arrows E-E in FIG. 12, FIG. 16 is a traverse cross-sectional view of the second connector according to Embodiment 1, FIG. 17 is a first perspective one-side cross-sectional view of the second connector according to Embodiment 1 and is a perspective one-side cross-sectional view taken along lien E-E in FIG. 12, FIG. 18 is a second perspective one-side cross-sectional view of the second connector according to Embodiment 1 and is a perspective one-side cross-sectional view taken along line F-F in FIG. 12, FIG. 19 is a third perspective one-side cross-sectional view of the second connector according to Embodiment 1 and is a perspective one-side cross-sectional view taken along line G-G in FIG. 12, and FIG. 20 is a fourth perspective one-side cross-sectional view of the second connector according to Embodiment 1 and is a perspective one-side cross-sectional view taken along line H-H in FIG. 12. In FIG. 11, (a) is an obliquely downward view, (b) is an obliquely upward view. In FIG. 13, (a) is a side view, (b) is a bottom view, and (c) is a front view. In FIG. 16, (a) is a cross-sectional view taken along a line indicated by arrows F-F in FIG. 12, (b) is a cross-sectional view taken along a line indicated by arrows G-G in FIG. 12, (c) is a cross-sectional view taken along a line indicated by arrows H-H in FIG. 12.

The second connector 101 according to the present Embodiment has: a second shield 150 as a shielding member, which is a plug shield formed by punching, drawing, or the like on a conductive metal plate; and a second housing 111 as a connector main body integrally formed by an insulating material such as a synthetic resin or the like. The second housing 111 has: a flat bottom plate 118; a second protruding part 112 serving as a protruding part protruding upwardly from an upper surface of the bottom plate 118 in a center in a longitudinal direction (X-axis direction) of the second connector 101; and a protruding end part 117 protruding upwardly from the upper surface of the bottom plate 118 at both ends in the longitudinal of the second connector 101.

The protruding end part 117 is a main portion that is connected to the second shield 150 when the second shield 150 is integrated with the second housing 111 by over-molding or insert molding. In other words, the second housing 111 is molded by filling a cavity of a mold in which the second shield 150 is internally set in advance, with an insulating material such as synthetic resin or the like, and is integrally connected to the second shield 150 at the protruding end part 117 and other portions. Therefore, the second housing 111 and the second shield 150 do not exist separately, but in FIG. 14, for convenience of description, the second housing 111 and the second shield 150 are illustrated as if they exist separately.

As illustrated in FIG. 14, each of the protruding end protruding end parts 117 has a shape of one of pieces obtained by dividing a tubular wall which is a square tube having a rectangular cross section in to, and has a rectangular U shape in plan view. Each protruding end part 117 includes a linear end wall part 117a extending in the width direction (Y-axis direction) of the second connector 101, and linear side wall parts 117c that extend in the longitudinal direction (X-axis direction) of the second connector 101 and are connected to both ends of the end wall part 117a via a curved wall part 117b. The curved wall part 117b is an arc-shaped portion having a central angle of about 90° in plan view. The lower end of the protruding end part 117 is connected to the tip end of a connecting part 118a extending outward at both ends of the bottom plate 118 in the longitudinal direction. In the illustrated example, the connecting part 118a is formed to be thicker than the other portions of the bottom plate 118.

On the inner side of each protruding end part 117, a protruding end recessed part 117d is formed on the lower side as a space with the lower side defined by the connecting part 118a, the ends on the outer side in the longitudinal direction defined by the end wall parts 117a, and the ends on both left and right sides defined by the side wall parts 117c. A metal fitting attachment part 116 connected to both ends of the second protruding part 112 in the longitudinal direction is accommodated in the protruding end recessed part 117d. The metal fitting attachment part 116 is a portion to which a second metal fitting 171 that is a power metal fitting is mounted.

The protruding end part 117 further includes a separation protruding part 117f that is continuous over the upper surface and the outer side surface of the side wall part 117c. The separation protruding part 117f is a protruding part formed at a position corresponding to a cutout part 150c that separate a long side part 150a and a short side part 150b of the second shield 150. In each protruding end part 117, the short side part 150b is integrally connected to a portion more on the outer side than the separation protruding part 117f in the longitudinal direction of the second connector 101, and the long side part 150a is integrally connected to a portion more on the inner side than the separation protruding part 117f in the longitudinal direction of the second connector 101.

The second protruding part 112 includes a pair of terminal supporting walls 112a extending in the longitudinal direction of the second connector 101 on both sides in the width direction of the second connector 101, and a center groove part 112b that is a space with the lower side defined by the bottom plate 118 and with ends on both left and right sides defined by terminal supporting walls 112a. The center groove part 112b is an elongated groove-shaped space defined by the metal fitting attachment part 116 at both ends in the longitudinal direction, and accommodates the inner side protruding parts 13b of the first connector 10 when the second connector 101 is mated with the first connector 10.

Furthermore, a side space 112c, which is an elongated recessed part extending in the longitudinal direction of the second connector 101, is formed between each terminal supporting wall 112a and the outer wall 152 of the long side part 150a. The side space 112c is formed in a range corresponding to at least the rows of the second terminals 161 in the longitudinal direction of the second connector 101.

The second terminals 161 that are terminals attached to the second housing 111 are attached to the terminal supporting walls 112a. The second terminals 161 are provided at a pitch corresponding to the first terminals 61 at a number corresponding to the first terminals such that at least part of the second terminals 161 are exposed on the surface of the terminal supporting wall 112a. Thus, the plurality of second terminals 161 are arranged along each of the terminal supporting walls 112a, to be arranged to form rows extending in the longitudinal direction of the second connector 101. The second terminals 161 may be attached to the terminal supporting walls 112a by press fitting, as in the case of the first terminals 61. Still, a case where the second terminals 161 are integrated with the terminal supporting walls 112a by over-molding or insert molding will be described herein for the sake of description.

A side recessed part 118b is formed in the bottom plate 118 on the outer side of the second protruding part 112 in the width direction of the second connector 101, and as a result, the bottom plate 118 has a smaller dimension in the width direction of the second connector 101, or in other words, is formed to a narrow width.

The metal fitting attachment parts 116 to which the second metal fittings 171 as the power metal fittings are attached are connected to both ends of the terminal supporting walls 112a in the longitudinal direction. Each metal fitting attachment part 116 has a rectangular U shape in plan view, and includes a linear end wall part 116a extending in the width direction of the second connector 101, and linear side wall parts 116b that extend in the longitudinal direction (X-axis direction) of the second connector 101 and are connected to both ends of the end wall part 116a. The outer side of the metal fitting attachment part 116 is surrounded by the protruding end part 117 via the protruding end recessed part 117d, with the end wall part 116a and the side wall part 116b respectively facing the end wall part 117a and the side wall part 117c of the protruding end part 117.

On the inner side surface of the end wall part 116a, a center recessed part 116c is formed that accommodates a center piece 178 of the second metal fitting 171. On the outer side surface of the side wall part 116b, a side recessed part 116d is formed that accommodates a side plate 175 of the second metal fitting 171. The side recessed part 116d is formed through the connecting part 118a of the bottom plate 118 from the outer side surface of the side wall parts 116b, to open on a mounting surface 101b side of the bottom plate 118 to expose the lower end of the side plate 175 of the second metal fitting 171 on the mounting surface 101b.

The second shield 150 is a member formed by performing punching, drawing, or the like on a conductive metal plate, and as illustrated in FIG. 12, is an essentially rectangular frame shaped member when viewed from above, in other words, in plan view, which encloses an entire circumference of the second housing 111. The second shield 150 includes a plurality of (in pair in the example illustrated in the drawings) the long side parts 150a as side shields which are first shielding members extending linearly in the longitudinal direction of the second connector 101, and a plurality of (in pair in the example shown in the drawings) short side parts 150b as end part shields which are second shielding members. The short side parts 150b enclosing both ends of the second housing 111 in the longitudinal direction include: a first part 150b1 that is a part linearly extending in the width direction of the second connector 101; second parts 150b2 connected to both ends of the first part 150b1 and have an arc shape with a central angle of approximately 90 degrees in plan view; and a third part 150b3 that are connected to the second parts 150b2 and linearly extends in the longitudinal direction of the second connector 101.

The long side part 150a and the short side part 150b are separated from each other by the cutout part 150c that is a narrow space between the long side part 150a and the third part 150b3 of the short side part 150b. Alternatively, the long side part 150a and the short side part 150b may be integrated with the cutout part 150c omitted if necessary. The long side part 150a and the short side part 150b will be collectively described as the second shield 150.

The second shield 150 includes the outer wall 152 as a shielding plate and a coupling part 153 having a base end connected to an upper end of the outer wall 152 and a tip end extending inward, but does not include a member substantially parallel to the outer wall 52 on the inner side of the outer wall 52, corresponding to the inner wall 51 of the first shield 50. The outer wall 152 and the coupling part 153 are continuous walls over the entire circumferences of the long side part 150a and the short side part 150b except for the cutout part 150c. The upper end part of the second shield 150 is a curved upper end part 153a of the coupling part 153, whereas the upper end part 153a in the short side part 150b is a flat plate shaped upper wall part 153c.

Engagement protruding parts 152c as a contact parts of an outwardly bulging shape are formed at a plurality of portions on the outer surface of the outer wall 152. Furthermore, the engagement protruding part 152c is a portion that engages with the engagement corner part 51c of the mating spring part 51a in the first shield 50 of the first connector 10 when the first connector 10 and the second connector 101 are in a mated state and extends linearly in the longitudinal direction or width direction of the second connector 101.

The short side part 150b functions as fixing parts that fix the second shield 150 to the first housing 11, and achieve the fixing by integral connection between the short side part 50b and the vicinity of both ends of the first housing 11 in the longitudinal direction with no gap in between. Specifically, the part is a portion integrated with the protruding end part 117 when the second shield 150 is integrated with the second housing 111 by over-molding or insert molding, and the first part 150b1, the second parts 150b2, and the third part 150b3 are respectively integrated with the end wall part 117a, the curved wall part 117b, and the side wall parts 117c. This ensures that the short side part 150b and the second housing 111 are firmly integrated and cannot be separated.

On the other hand, the fixing part of the long side part 150a in the longitudinal direction is integrated with a portion of the protruding end part 117 that is more on the inner side than the separation protruding part 117f of the side wall parts 117c in the longitudinal direction of the second connector 101, when the second shield 150 is integrated with the second housing 111 by over-molding or insert molding. In each long side part 150a, an end joint part 155 for fixedly connecting the long side part 150a and the second housing 111 is formed at both ends in the longitudinal direction. The end joint part 155 functions as a fixing part for fixing the second shield 150 to the second housing 111, and integrally connects and fixes both ends of the long side part 150a in the longitudinal direction and the vicinity of both ends of the second housing 111 in the longitudinal direction with no gap therebetween. The end joint part 155 is a member formed by bending an strip whose base end is connected to the long side part 150a and whose tip end is embedded in a portion of the side wall parts 117c that is more on the inner side than the separation protruding part 117f of the side wall parts 117c in the longitudinal direction of the second connector 101. Specifically, the end joint part 155 includes a base end part 155a whose upper end is connected to the upper end part 153a of the coupling part 153 which is the upper end part of the second shield 150, and a vertical part 155b extending substantially vertically downward from the lower end of the base end part 155a.

When the second shield 150 is integrated with the second housing 111 by over-molding or insert molding, the end joint part 155 is integrated with a portion that is more on the inner side than the separation protruding part 117f of the side wall parts 117c in the longitudinal direction of the second connector 101, the base end part 155a is exposed on the surface of the side wall parts 117c, and the vertical part 155b is embedded in the side wall parts 117c. This ensures that the long side part 150a and the second housing 111 are firmly integrated and cannot be separated.

In each long side part 150a, an intermediate joint part 156 as a joint part connecting the long side part 150a and the second housing 111 is formed at any position between the end joint parts 155 at both ends in the longitudinal direction. In the example illustrated in the drawings, one intermediate joint part 156 is formed at the center of each long side part 150a in the longitudinal direction, but the intermediate joint part 156 is not necessarily formed at the center of the long side part 150a in the longitudinal direction, and may be formed at any position of the long side part 150a in the longitudinal direction, or two or more intermediate joint parts 156 may be formed. Here, for convenience of explanation, only a case where one intermediate joint part 156 is formed at the center of each long side part 150a in the longitudinal direction will be described.

The intermediate joint part 156 is a member formed by bending an elongated strip whose base end is connected to the long side part 150a and whose tip end is embedded in an intermediate joint holding part 112d of the terminal supporting walls 112a. The second terminal 161 is not attached to a portion of the second housing 111 corresponding to the intermediate joint part 156. The intermediate joint part 156 extends from the upper end of the outer wall 152 toward a mounting surface 101b of the second connector 101, and then extends toward the second housing 111. The tip end of the intermediate joint part 156 is fixed to the second housing 111 between the second terminals 161 adjacent to each other in the longitudinal direction of the second connector 101. Specifically, the intermediate joint part 156 includes: a base end part 156a that has an upper end connected to the upper end part 153a of the coupling part 153 that is the upper end part of the second shield 150; a first vertical part 156b that extends substantially vertically downward from the lower end of the base end part 156a; a first horizontal part 156c that extends substantially horizontally from the lower end of the first vertical part 156b toward the center of the second connector 101 in the width direction; and a second vertical part 156d that extends substantially vertically upward from the tip end of the first horizontal part 156c.

When the second shield 150 is integrated with the second housing 111 by over-molding or insert molding, approximately half of the first horizontal part 156c is integrated with the bottom plate 118 to exposed on the lower surface of the bottom plate 118, and the second vertical part 156d is mostly integrated with the intermediate joint holding part 112d to be exposed on the side surface of the intermediate joint holding part 112d. Thus, the long side part 150a and the second housing 111 are also integrated with each other at an intermediate portion in the longitudinal direction, and thus have the orientation and the shape stably maintained. Part of the intermediate joint part 156 can be electrically connected to the second substrate. Specifically, the first horizontal part 156c is preferably electrically connected to a connection pad on the surface of the second substrate.

A flange part 154 serving as an outwardly extending flat part is connected to the lower end of the outer wall 152 through a bent part 152a bent at an angle of approximately 90 degrees. The bent part 152a and the flange part 154 are connected to the lower end of the outer wall 152 in a continuous manner around the entire circumference, except for the cutout part 150c. Note that in the example illustrated in the drawings, a small notch 154a is formed in a plurality of locations on the flange part 154, but the notch 154a can be omitted as appropriate.

The flange part 154 functions as a substrate connecting part, a lower surface of which is parallel to the surface of the second substrate and is a portion connected by soldering or the like to the connection pad on the surface. The connection pad is typically connected to a ground line. Furthermore, the outer wall 152, in addition to being a continuous wall itself, is connected to a portion where an upper end thereof is continuous at the coupling part 153, which is a portion a location extending in a direction orthogonal to the outer wall 152 in a cross section as illustrated in FIGS. 15 and 16 and is connected to a member where a lower end thereof is continuous as with the flange part 154, which is a member extending in a direction orthogonal to the outer wall 152 in the cross section as illustrated in FIGS. 15 and 16. Therefore, the outer wall 152 is relatively rigid and resistant to deformation.

The second terminal 161 is a member integrally formed by punching, bending, or the like on a conductive metal plate, and has: an inner side connecting part 165 extending in the vertical direction (Z-axis direction); a tail part 162 as a substrate connecting part that is connected to a lower end of the outer side connecting part 165 and extends outward in the width direction of the second housing 111; an upper side connecting part 164 connected to the upper end of the outer side connecting part 165; and an outer side connecting part 166 connected to the lower end of the upper side connecting part 164 and facing the inner side connecting part 165. The tail part 162 extends in the horizontal direction (Y-axis direction) while passing below the outer side connecting part 166, and the tip end thereof is positioned more on the outer side than the outer side connecting part 166. The second terminals 161 may be integrated with the second housing 111 by over-molding or insert molding. That is, the second housing 111 is molded by filling a cavity of a mold in which the second terminals 161 are set in advance with an insulating material such as a synthetic resin.

As a result, the second terminal 161 is integrally attached to the terminal supporting wall 112a such that at least a portion thereof is embedded in the terminal supporting wall 112a of the second protruding part 112 in the second housing 111, and substantially entirety of the surface of the inner side connecting part 165 and the upper side connecting part 164, as well as at least part of the surface of the outer side connecting part 166 are exposed on an inner side surface, the upper surface, and outer side surface of the terminal supporting wall 112a. Note that the surfaces of the inner side connecting part 165 and the outer side connecting part 166 function as contacting parts, and contact the first terminal 61 that the first connector 10 is provided with.

Furthermore, the tail part 162 extends to an outer side in the width direction of the second housing 111 from the terminal supporting wall 112a and is connected by soldering or the like to a connection pad connected to a conductive trace of the second substrate. The conductive trace is typically a signal line.

Furthermore, the second terminal 161 is not necessarily integrated with the second housing 111 by overmolding or insert molding but may be attached to the second housing 111 by press fitting or the like. Herein, for convenience of description, a case of integrating with the second housing 111 by overmolding or insert molding will be described.

The second metal fitting 171 is a member integrally formed by performing punching, bending, and the like on a conductive metal plate, and includes a top plate part 172 covering at least part of the upper surface of the end wall part 116a of the metal fitting attachment part 116, and the pair of side plates 175 covering at least part of the outer side surface of the side wall parts 116b of the metal fitting attachment part 116. Note that the top plate part 172 contains a front connecting part 172a and a side connecting part 172b. The side plate 175 is connected to a tip end of the side connecting part 172b, and the center piece 178 is connected to a tip end of the front connecting part 172a. Furthermore, a contact piece 175a extending obliquely downward toward the bottom surface of the center groove part 112b is connected to an upper end of the side plate 175.

The second metal fitting 171 is attached to the metal fitting attachment part 116, with the side plate 175 press fitted into the side recessed part 116d from the side of a mating surface 101a that is an upper surface (Z-axis negative direction surface) of the second connector 101. Note that the second metal fitting 171 is not necessarily attached to the second housing 111 by press fitting but may be integrated with the second housing 111 by over-molding or insert molding. Herein, for convenience of description, a case in which the side plate 175 pressed into and retained by the side recessed part 116d will be described.

The lower end of the side plate 175 accommodated in the side recessed part 116d open on the mounting surface 101b side of the bottom plate 118 is exposed on the mounting surface 101b, and is connected to the connection pad coupled to the conductive trace of the second substrate by soldering or the like. It should be noted that the conductive traces are described as power lines, i.e., power lines, which carry power.

The contact piece 175a is not in contact with the side wall parts 116b or the like in the state where the second metal fitting 171 is attached to the metal fitting attachment part 116, and is a cantilevered member elastically deformable toward the outer side in the width direction of the second connector 101. The contact piece 175a functions as a contacting part, and comes into conductive contact with the outer side surface of the side plate part 74 of the first metal fittings 71, when the first connector 10 and the second connector 101 mate. The center piece 178 also functions as a contacting part, and comes into conductive contact with the outer side surface of the coupling piece 73 of the first metal fittings 71, when the first connector 10 and the second connector 101 mate.

The second metal fitting 171 functions not only as a power metal fitting for transmitting power but also as a protective metal fitting for protecting both ends of the second protruding part 112 in the longitudinal direction.

Furthermore, the second connector 101 is placed on the surface of the second substrate with solder applied to the mounting surface 101b side of the second shield 150, the second terminals 161, the second metal fitting 171, and the like and is fixed and mounted on the surface of the second substrate by heating and melting the solder using a heating furnace or the like. The solder is applied by applying a solder sheet, applying a solder paste, transferring a cream solder, dipping, jet soldering, or the like. Note that means for connecting the second shield 150, the second terminals 161, the second metal fitting 171, and the like to the connection pad of the second substrate and the like are not necessarily limited to soldering and may be, for example, conductive adhesive or the like. Still, a case where a solder sheet is used will be described herein.

Specifically, the solder is applied to the lower surface of a flange part 154 corresponding to the long side part 150a and the short side part 150b of the second shield 150, and is also applied to each of the lower surfaces of the tail part 162 of each of the second terminals 161 and the lower surfaces of the tail part 162 and the side plate 175 of the second metal fitting 171. Preferably, the solder is also applied to the lower surface of the first horizontal part 156c of the intermediate joint part 156.

When the solder applied in this manner is heated and melted, and the second connector 101 is mounted on the surface of the second substrate, the bent part 152a and the flange part 154, which are continuously connected to the lower end of the outer wall 152 that is continuous over the long side part 150a and the short side part 150b of the second shield 150, are connected to the connection pads on the surface of the second substrate without a gap. Therefore, the strength of the long side part 150a and the short side part 150b of the second shield 150 connected to the connection pads on the surface of the second substrate is high, and consequently, the strength of the entire second connector 101 with an outer circumference surrounded by the long side part 150a and the short side part 150b is high. Furthermore, an electromagnetic shielding effect exerted by the long side part 150a and the short side part 150b, which is connected without a gap to the connection pads on the surface of the second substrate, is very high, and the second connector 101 with an outer circumference surrounded by the long side part 150a and the short side part 150b is very effectively electromagnetically shielded.

In particular, the smoothness of the lower surface of the flange part 154 is high. Thus, the strength of the long side part 150a and the short side part 150b connected to the connection pads on the surface of the second substrate can be made extremely high. Moreover, since no gap is created between the connection pads on the surface of the second substrate, the electromagnetic shielding effect can also be made extremely high.

The long side part 150a that extends long in the longitudinal direction of the second connector 101 has both ends in the longitudinal direction, including the end joint part 155, integrated with the portions more on the inner side than the separation protruding part 117f of the protruding end part 117 in the longitudinal direction of the second connector 101. Furthermore, an intermediate portion in the longitudinal direction including the tip end of the intermediate joint part 156 is integrated with the bottom plate 118 and the terminal supporting walls 112a in the longitudinal direction of the second housing 111. Thus, the decrease in the flatness of the flange part 154 in the long side part 150a due to warpage of the second housing 111 which is an elongated member made of an insulating material such as synthetic resin is reliably prevented. Furthermore, the connection between the flange part 154 and the bent part 152a of the long side part 150a and the connection pads on the surface of the second substrate is reliably maintained. When the lower surface of the first horizontal part 156c of the intermediate joint part 156 is also soldered onto the connection pads on the surface of the second substrate, the decrease in the flatness of the flange part 154 of the long side part 150a is more reliably prevented.

Next, the operation of mating together the first connector 10 and the second connector 101 with the above configuration will be described.

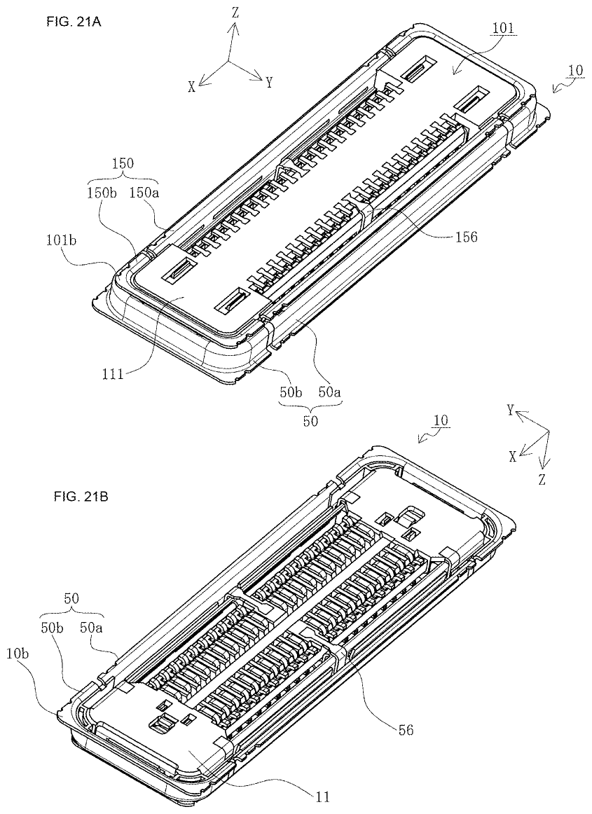

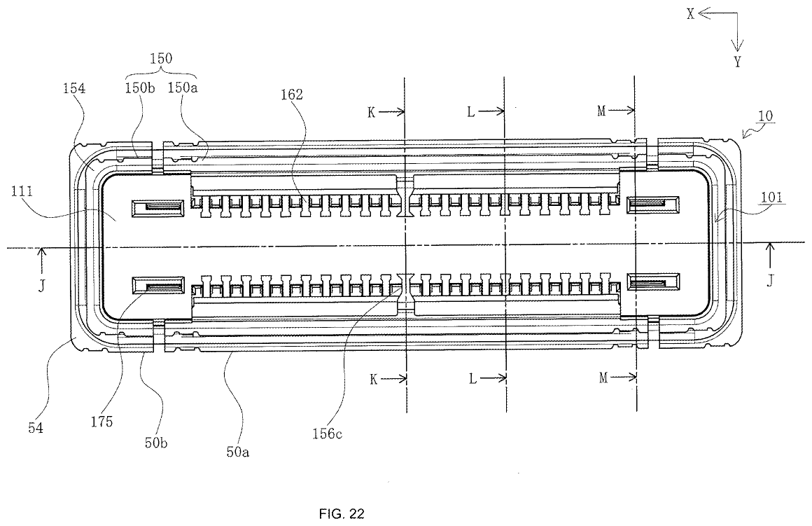

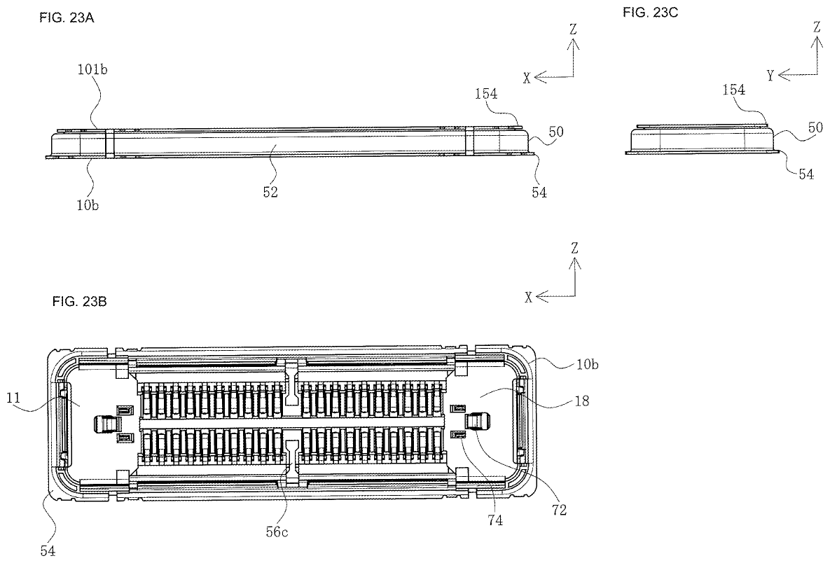

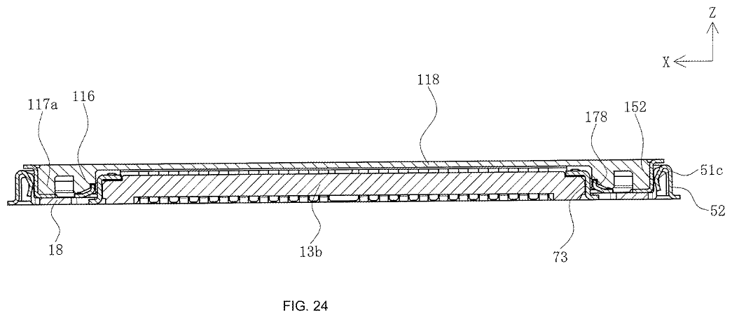

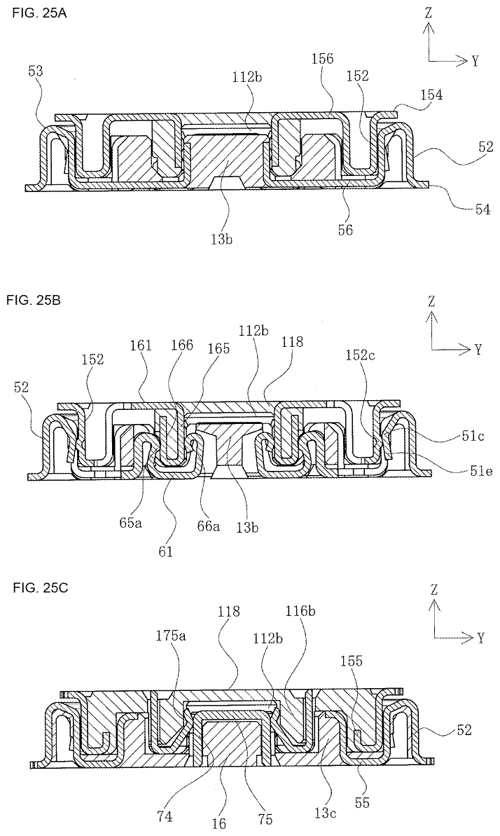

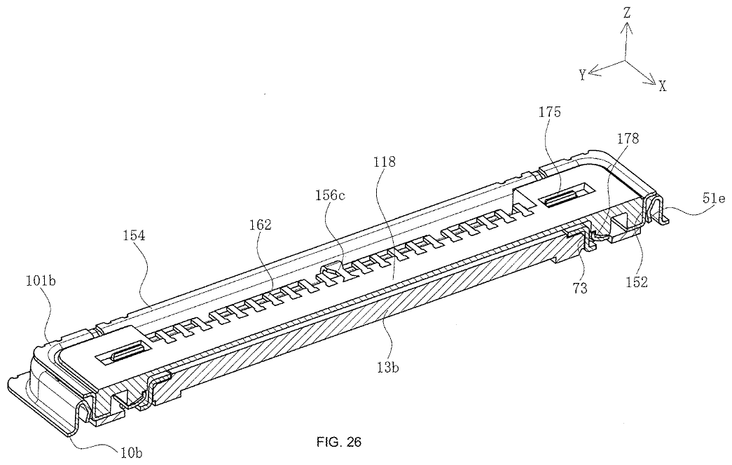

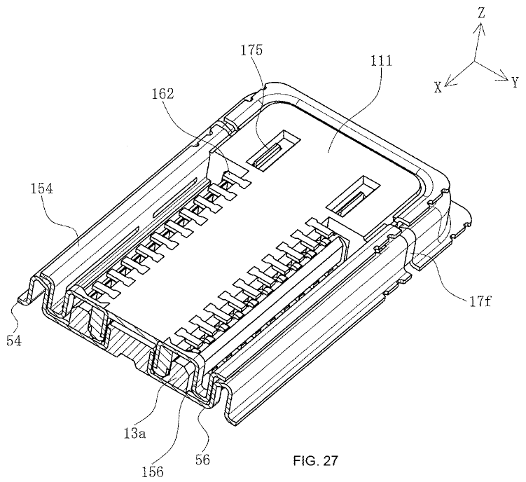

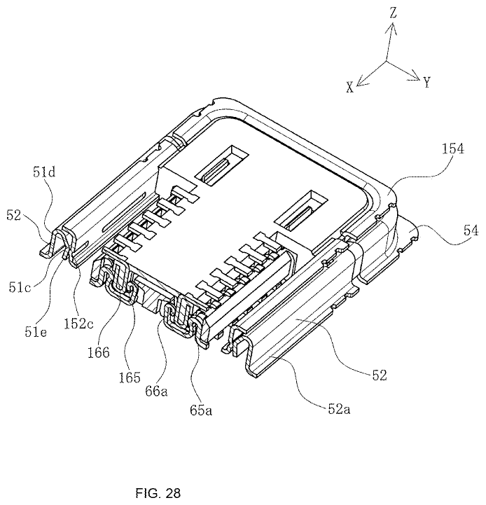

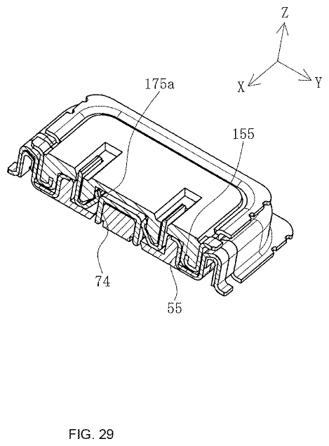

FIG. 21 is a perspective view of a completed mating state of the first connector and the second connector according to Embodiment 1, FIG. 22 is a plan view of the completed mating state of the first connector and the second connector according to Embodiment 1 as viewed from above the first connector, FIG. 23 includes three views of the completed mating state of the first connector and the second connector according to Embodiment 1, FIG. 24 is a side cross-sectional view of the completed mating state of the first connector and the second connector according to Embodiment 1 and is a cross-sectional view taken along a line indicated by arrows J-J in FIG. 22, FIG. 25 is a traverse cross-sectional view of the completed mating state of the first connector and the second connector according to Embodiment 1, FIG. 26 is a first perspective one-side cross-sectional view of the completed mating state of the first connector and the second connector according to Embodiment 1 and is a cross-sectional view taken along a line indicated by arrows J-J in FIG. 22, FIG. 27 is a second perspective one-side cross-sectional view of the completed mating state of the first connector and the second connector according to Embodiment 1 and is a cross-sectional view taken along a line indicated by arrows K-K in FIG. 22, FIG. 28 is a third perspective one-side cross-sectional view of the completed mating state of the first connector and the second connector according to Embodiment 1 and is a cross-sectional view taken along a line indicated by arrows L-L in FIG. 22, and FIG. 29 is a fourth perspective one-side cross-sectional view of the completed mating state of the first connector and the second connector according to Embodiment 1 and is a cross-sectional view taken along a line indicated by arrows M-M in FIG. 22. In FIG. 21, (a) is an obliquely upward view of the first connector, (b) is an obliquely downward view of the first connector. In FIG. 23, (a) is a side view, (b) is a plan view of the second connector as viewed from above, and (c) is a front view. In FIG. 25, (a) is a cross-sectional view taken along a line indicated by arrows K-K in FIG. 22, (b) is a cross-sectional view taken along a line indicated by arrows L-L in FIG. 22, (c) is a cross-sectional view taken along a line indicated by arrows M-M in FIG. 22.

Herein, the first connector 10 is surface mounted to the first substrate by connecting the tail part 62 of the first terminal 61, the tail part 72 and the side plate part 74 of the first metal fittings 71, the bent part 52a and the flange part 54, which are continuously connected to the lower end of the outer wall 52, the first horizontal part 55c of the end joint part 55, and the first horizontal part 56c of the intermediate joint part 56 to a connection pad connected to a conductive trace of the first substrate (not illustrated) by soldering. A conductive trace connected to the connection pad to which the tail part 72 and the side plate part 74 of the first metal fittings 71 is connected is a power line that transmits power. A conductive trace connected to the connection pad to which the bent part 52a of the first shield 50, the flange part 54, the first horizontal part 55c of the end joint part 55, and the first horizontal part 56c of the intermediate joint part 56 are connected is a ground line. Moreover, a conductive trace connected to the connection pad to which the tail part 62 of the first terminal 61 is connected is a signal line, which transmits a signal.

Similarly, the second connector 101 is surface mounted to the second substrate by connecting the tail part 162 of the second terminals 161, the side plate 175 of the second metal fitting 171, the bent part 152a and the flange part 154, which are continuously connected to the lower end of the outer wall 152, the first horizontal part 156c of the intermediate joint part 156, and the first horizontal part 156c of the intermediate joint part 156 to a connection pad connected to a conductive trace of the second substrate (not illustrated) by soldering. A conductive trace connected to the connection pad to which the side plate 175 of the second metal fitting 171 is connected is a power line that transmits power. A conductive trace connected to the connection pad to which the bent part 152a of the second shield 150, the flange part 154, the first horizontal part 156c of the intermediate joint part 156 are connected is a ground line. Moreover, a conductive trace connected to the connection pad to which the tail part 162 of the second terminal 161 is connected is a signal line, which transmits a signal.

First, an operator places the mating surface 10a of the first connector 10 and the mating surface 101a of the second connector 101 so as to face each other and when the position of the inner side protruding parts 13b of the first connector 10 matches the position of the center groove part 112b of the second connector 101 and the position of the protruding end part 117 of the second connector 101 matches the position of the mating recess part 12b corresponding to the first connector 10, the positioning of the first connector 10 and the second connector 101 is completed.

In this state, when the first connector 10 and/or the second connector 101 are moved in a direction approaching a counterpart side, in other words, in a mating direction, the second shield 150 of the second connector 101 is inserted into the housing part 50d of the first shield 50 of the first connector 10, the inner side protruding part 13b of the first connector 10 is inserted into the center groove part 112b of the second connector 101, and the protruding end part 117 of the second connector 101 is inserted into the mating recess part 12b of the first connector 10.

Note that the coupling part 53 of the first shield 50 is present on the mating surface 10a of the first connector 10 so as to surround a circumference thereof, and the coupling part 153 of the second shield 150 are present on the mating surface 101a of the second connector 101. Therefore, the mating surface 10a of the first connector 10 and the mating surface 101a of the second connector 101 will not be damaged or broken even when coming into contact with each other.

Furthermore, in the initial mating state, or in other words, in a state where the portion near the mating surface 101a of the second connector 101 enters slightly into the housing part 50d of the first shield 50 of the first connector 10, the portion near the mating surface 101a of the outer wall 152 at the short side part 150b of the second shield 150 comes into contact with the gradual oblique surface near the upper end of the mating positioning part 51b (near the mating surface 10a) in the short side part 50b of the first shield 50, and is inserted into the housing part 50d while in contact with and being guided by the gradual oblique surface. Thereby, the second connector 101 is positioned with respect to the first connector 10. The mating positioning part 51b is integrated with the corner parts 17 of the first housing 11 and thus is rigid. Therefore, the mating positioning part 51b has high robustness, and even if the portion near the mating surface 101a of the second shield 150 of the second connector 101 comes into contact with the mating positioning part 51b, the mating positioning part 51b will not be deformed or damaged.

Furthermore, the portion near the mating surface 101a of the outer wall 152 at the short side part 150b of the second shield 150 comes into contact with the oblique surface part 51d of the mating spring part 51a of the first shield 50 after coming into contact with the gradual oblique surface. As a result, damage to the mating spring part 51a can be reduced.

Thus, as illustrated in FIGS. 21 to 29, when the mating of the first connector 10 and the second connector 101 is completed, the first terminal 61 and the second terminal 161 conduct electricity, and the first metal fittings 71 and the second metal fitting 171 achieve an electrically conductive state.

Specifically, the pair of terminal support walls 112a of the second protruding part 112 of the second housing 111 are inserted into the pair of inner recessed groove parts 12a of the first housing 11, and the contacting part 65a of the outer side connecting part 65 and the contact part 66a of the inner side connecting part 66 of the first terminal 61 that protrude into the inner groove portion 12a and face each other come into contact with the outer side connecting part 166 and the inner side connecting part 165 of the second terminal 161 exposed on the outer side surface and the inner side surface of the terminal supporting wall 112a.

At this time, the lower side connecting parts 64 of the first terminal 61 and a vicinity thereof have an essentially U-shaped shape and are elastically deformable, such that the interval between the mutually facing outer side connecting part 65 contacting part 65a and the inner side connecting part 66 contacting part 66a is elastically expandable. Therefore, the interval between the contacting part 65a on the outer side connecting part 65 and the contacting part 66a on the inner side connecting part 66 are elastically pushed apart by the second terminal 161 inserted therebetween and as a reaction thereof, the second terminal 161 is elastically sandwiched from two sides by the contacting part 65a of the outer side connecting part 65 and the contacting part 66a of the inner side connecting part 66. As a result, the contacting part 65a of the outer side connecting part 65 of the first terminal 61 and the outer side connecting part 166 of the second terminal 161, as well as the contacting part 66a of the inner side connecting part 66 of the first terminal 61 and the inner side connecting part 165 of the second terminal 161 maintain contact and do not separate even when subjected to shock or vibration and thus can maintain a stable state of electrical conduction. Furthermore, the mutually corresponding first terminal 61 and second terminal 161 are in a state of contact at two points, a so-called two-point contact, and even if contact at one point is released, the contact at the other point is maintained, and thus a contact state can be stably maintained.

In this manner, the first terminal 61 and second terminal 161, which are in contact with each other, have entire circumferences that are continuously surrounded by the inner wall 51 and outer wall 52 of the first shield 50 and the outer wall 152 of the second shield 150, and moreover, are continuously enclosed, thereby being extremely effectively shielded. Therefore, good electromagnetic compatibility (EMC) can be achieved.

The metal fitting attachment parts 16 connected to both ends of the inner side protruding parts 13b in the longitudinal direction are inserted in the vicinity of both ends of the center groove part 112b. The coupling piece 73 and the side plate part 74 of the first metal fitting 71 come into contact with the center piece 178 and the contact piece 175a of the second metal fitting 171. The contact piece 175a is elastically deformable and thus is elastically displaceable in the width direction of the first connector 10 and the second connector 101. As a result, the side plate part 74 of the first metal fittings 71 and the contact piece 175a of the second metal fitting 171 corresponding to each other maintain contact and do not separate even when subjected to shock or vibration, and thus can maintain a stable state of electrical conduction. Therefore, power can be stably transmitted.

Furthermore, when the second shield 150 of the second connector 101 is inserted into the housing part 50d of the first shield 50 of the first connector 10, the outer surface of the outer wall 152 of the second shield 150 contacts or approaches the inner surface of the inner wall 51 of the first shield 50 and as illustrated in FIGS. 25(b) and 28, the engagement protruding parts 152c formed on the outer wall 152 of the second shield 150 and the engagement corner part 51c formed on the inner wall 51 of the first shield 50 are engaged. Note that both ends of the mating spring part 51a of the inner wall 51, in which the engagement corner part 51c is formed, is separated from another portion by the slit part 53b at two ends thereof and is relatively flexible; and a state of engagement with the engagement protruding parts 152c of the outer wall 152 of the second shield 150 can be reliably maintained. As a result, the first shield 50 and the second shield 150 become locked and release of the mating state between the first connector 10 and the second connector 101 is prevented. Furthermore, the first shield 50 and the second shield 150 are in contact with each other and are electrically conductive and at equipotential, and therefore, electromagnetic shielding is improved.

The long side part 50a of the first shield 50 includes the intermediate joint part 56 connecting an intermediate part thereof to an intermediate part of the first housing 11 in the longitudinal direction. The long side part 150a of the second shield 150 includes the intermediate joint part 156 connecting an intermediate part thereof to the an intermediate part of the second housing 111 in the longitudinal direction. Thus, even when the first connector 10 and the second connector 101 have an elongated shape due to a larger number of poles, the decrease in flange is reliably prevented for the lower surface (the mounting surfaces 10b and 101b) of the flange parts 54 and 154 of the long side part 50a of the first shield 50 and the long side part 150a of the second shield 150 due to warpage of the first housing 11 and the second housing 111 that are elongated members made of an insulating material such as synthetic resin. As a result, the connection of the flange parts 54 and 154 and the bent parts 52a and 152a to the connection pads on the surfaces of the first substrate and the second substrate is reliably maintained. Therefore, good electromagnetic compatibility (EMC) can be maintained.

The lower surfaces of the first horizontal parts 56c and 156c of the intermediate joint parts 56 and 156 are connected to the connection pads coupled to the ground line on the surfaces of the first substrate and the second substrate. Thus, even when the long side parts 50a and 150a are long, the equipotential can be maintained over the entire range thereof of in the longitudinal direction. Therefore, even better electromagnetic compatibility (EMC) can be maintained.

As described above, in the present Embodiment, the first connector 10 includes the first housing 11, the plurality of first terminals 61 attached to the first housing 11, and the first shield 50 that encloses the first housing 11, and mates with the second connector 101. The second connector 101 includes the second housing 111, the plurality of second terminals 161 attached to the second housing 111, and the second shield 150 that surrounds the second housing 111, and mates with the first connector 10. The first terminals 61 and the second terminals 161 are arranged to form rows extending in the longitudinal direction of the first connector 10 and the second connector 101. The first shield 50 and the second shield 150 include the end joint parts 55 and 155, the outer walls 52 and 152, and the intermediate joint parts 56 and 156. The end joint parts 55 and 155 integrally connect and fix the first shield 50 and the second shield 150 to the first housing 11 and the second housing 111 with no gap in between in the vicinity of both ends of the first housing 11 and the second housing 111 in the longitudinal direction. The outer walls 52 and 152 are disposed on the outer side of the first housing 11 and the second housing 111 in the width direction, at least in a range corresponding to the rows of the first terminals 61 and the second terminals 161 in the longitudinal direction of the first connector 10 and the second connector 101, with the side spaces 12c and 112c provided in between. The intermediate joint parts 56 and 156 connect the outer walls 52 and 152 to the first housing 11 and the second housing 111 across the side spaces 12c and 112c in the range corresponding to the rows of the first terminals 61 and the second terminals 161.

Thus, the first connector 10 and the second connector 101 can have high strength while being compact and low profile, and can further provide high shielding effect to achieve improved reliability.

The intermediate joint parts 56 and 156 extend from the upper ends of the outer walls 52 and 152 toward the mounting surfaces 10b and 101b of the first connector 10 and the second connector 101 and toward the first housing 11 and the second housing 111, and have the tip ends fixed to the first housing 11 and the second housing 111 between the first terminal 61 and the second terminal 161 adjacent to each other in the longitudinal direction of the first connector 10 and the second connector 101. Part of the intermediate joint parts 56 and 156 can be electrically connected to the first substrate and the second substrate on which the first connector 10 and the second connector 101 are mounted. The flange parts 54 and 154 parallel to the surfaces of the first substrate and the second substrate on which the first connector 10 and the second connector 101 are mounted can be formed on the outer walls 52 and 152. The first shield 50 and the second shield 150 may include the short side parts 50b and 150b that may enclose both ends of the first housing 11 and the second housing 111 in the longitudinal direction. The short side parts 50b and 150b may be integrated with the first shield 50 and the second shield 150. The first shield 50 surrounds the periphery of the housing part 50d in which the second connector 101 is inserted and housed, the outer wall 52 includes at least two mating spring parts 51a that come into contact with the outer wall 152 of the second connector 101, and the intermediate joint part 56 is formed between the mating spring parts 51a adjacent to each other. The outer wall 152 may include the engagement protruding parts 152c formed to protrude outward from the outer surface.

Next, Embodiment 2 will be described below. Note that, for portions having the same structure as that of Embodiment 1, descriptions thereof are omitted by giving the same reference numerals thereto. Moreover, descriptions of the same operations and effects as those of Embodiment 1 will be omitted.

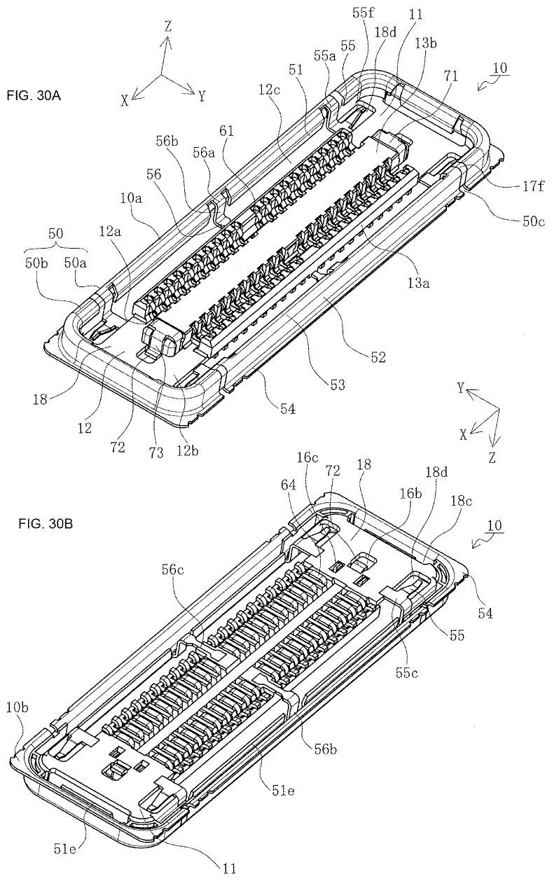

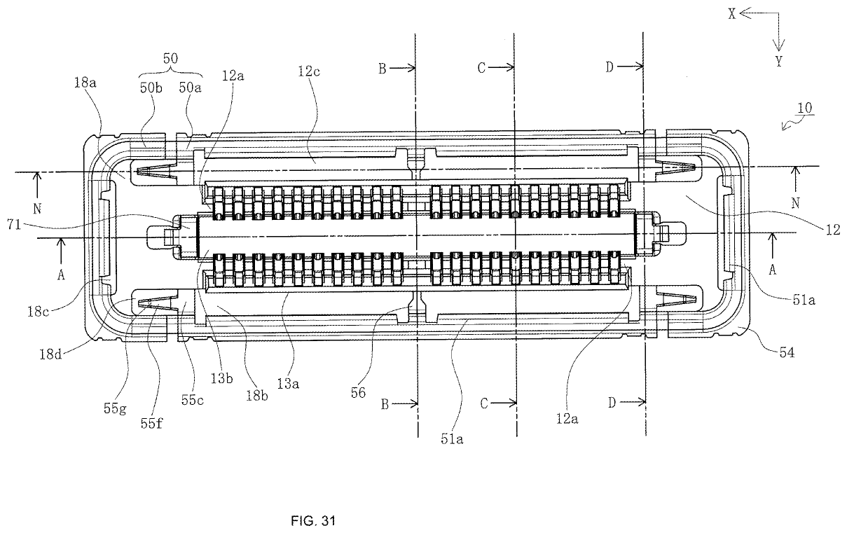

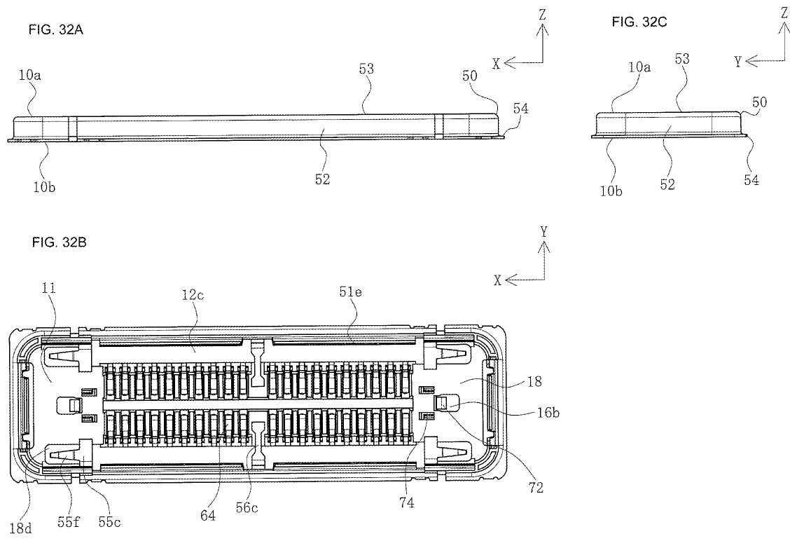

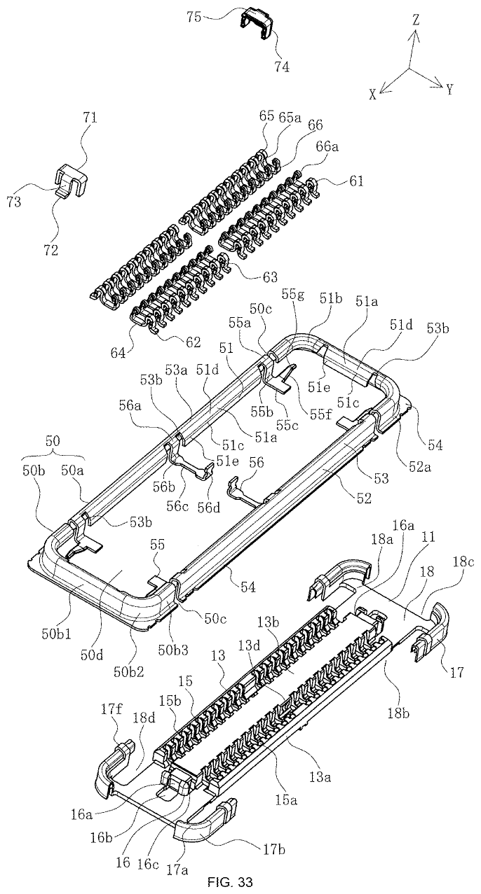

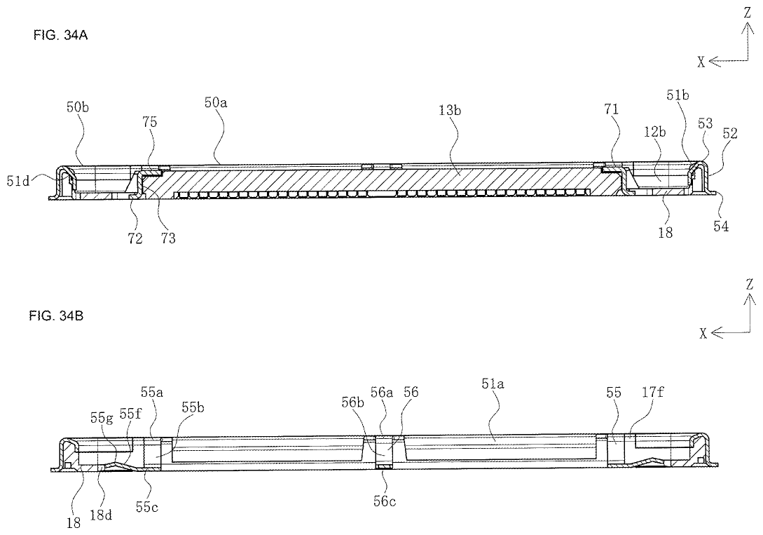

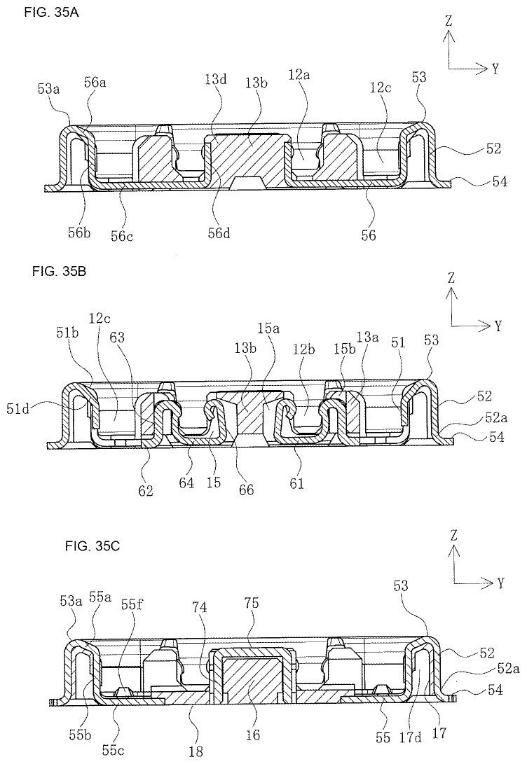

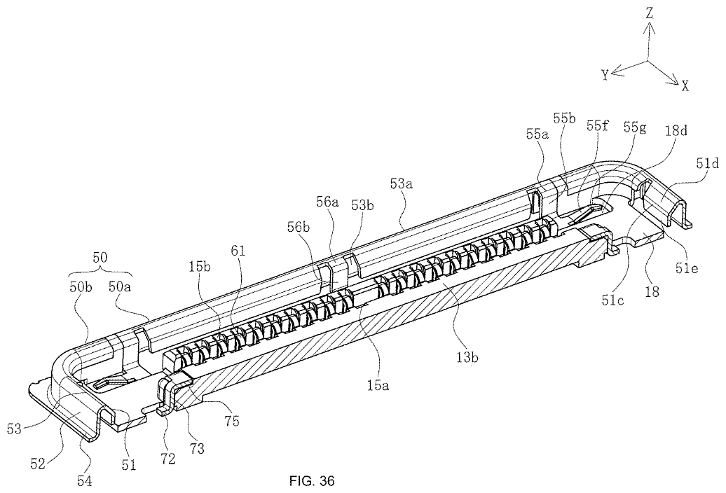

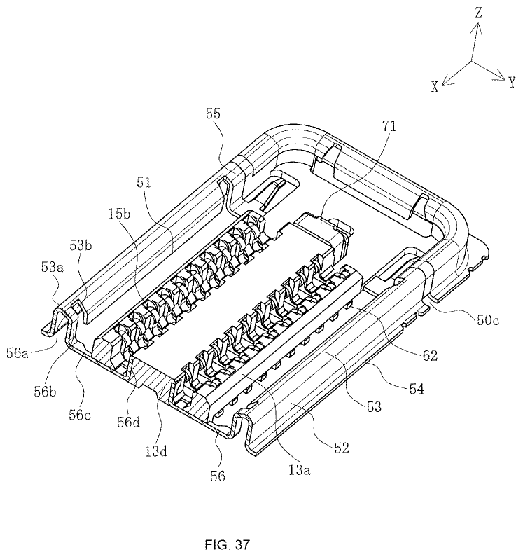

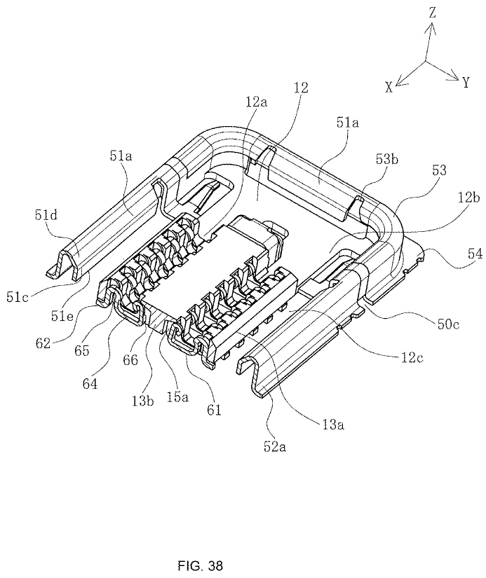

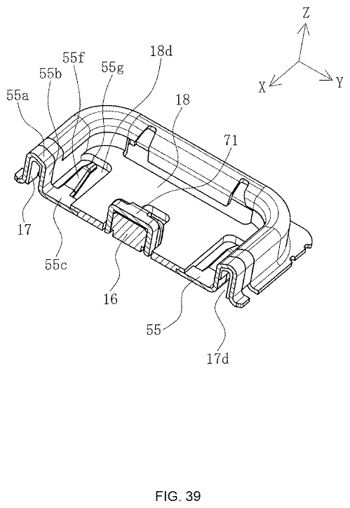

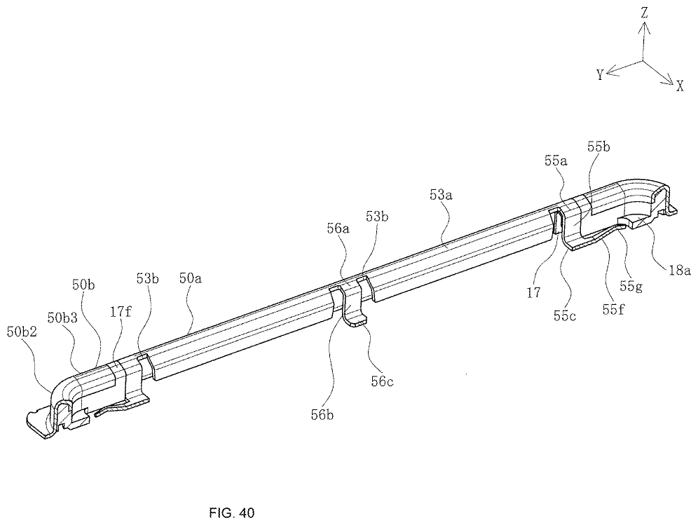

FIG. 30 is a perspective view of a first connector according to Embodiment 2, FIG. 31 is a top view of the first connector according to Embodiment 2, FIG. 32 includes three views of the first connector according to Embodiment 2, FIG. 33 is an exploded perspective view of the first connector according to Embodiment 2, FIG. 34 is a side cross-sectional view of the first connector according to Embodiment 2, FIG. 35 is a traverse cross-sectional view of the first connector according to Embodiment 2, FIG. 36 is a first perspective one-side cross-sectional view of the first connector according to Embodiment 2 and is a perspective one-side cross-sectional view taken along line A-A in FIG. 31, FIG. 37 is a second perspective one-side cross-sectional view of the first connector according to Embodiment 2 and is a perspective one-side cross-sectional view taken along line B-B in FIG. 31, FIG. 38 is a third perspective one-side cross-sectional view of the first connector according to Embodiment 2 and is a perspective one-side cross-sectional view taken along line C-C in FIG. 31, FIG. 39 is a fourth perspective one-side cross-sectional view of the first connector according to Embodiment 2 and is a perspective one-side cross-sectional view taken along line D-D in FIG. 31, and FIG. 40 is a fifth perspective one-side cross-sectional view of the first connector according to Embodiment 2 and is a perspective one-side cross-sectional view taken along line N-N in FIG. 31. In FIG. 30, (a) is an obliquely upward view, (b) is an obliquely downward view. In FIG. 32, (a) is a side view, (b) is a bottom view, and (c) is a front view. In FIG. 34, (a) is a cross-sectional view taken along a line indicated by arrows A-A in FIG. 31 and (b) is a cross-sectional view taken along a line indicated by arrows N-N in FIG. 31. In FIG. 35, (a) is a cross-sectional view taken along a line indicated by arrows B-B in FIG. 31, (b) is a cross-sectional view taken along a line indicated by arrows C-C in FIG. 31, (c) is a cross-sectional view taken along a line indicated by arrows D-D in FIG. 31.

In the present Embodiment, the first shield 50 has a substantially rectangular shape in plan view with the four sides coming into contact with the second shield 150 of the second connector 101. The first connector 10 includes contact pieces 55f that are elastically displaceable in the mating direction and are disposed in the vicinity of the four corner parts of the first shield 50. The contact pieces 55f come into contact with the second shield 150 of the second connector 101.

Specifically, the end joint part 55 of the first shield 50 of the present Embodiment includes: the base end part 55a that has an upper end connected to the upper end part 53a of the coupling part 53 that is the upper end part of the first shield 50; the first vertical part 55b that extends substantially vertically downward from the lower end of the base end part 55a; the first horizontal part 55c that extends substantially horizontally from the lower end of the first vertical part 55b toward the center of the first connector 10 in the width direction (Y-axis direction); and the contact pieces 55f of a cantilever shape extending outward in the longitudinal direction of the first connector 10 from the outer side edge of the first horizontal part 55c in the longitudinal direction of the first connector 10. The contact pieces 55f are inclined to have a portion farther from the first horizontal part 55c positioned higher in side view, that is, as viewed in the Y-axis direction, and to have a vertex 55g formed in the vicinity of the free end thereof functioning as a contact point that comes into contact with the second shield 150 of the second connector 101. In the end joint part 55 according the present Embodiment, the second vertical part 55d and the second horizontal part 55e of the end joint part 55 according to Embodiment 1 are omitted.

In the first housing 11 according to the present embodiment, the outer end protruding part 13c is omitted and a side recess extension part 18d is formed. The side recess extension part 18d is a portion formed to extend outward in the longitudinal direction of the first connector 10 from the outer side end of each side recessed part 18b in the longitudinal direction of the first connector 10. Thus, a narrow portion in the bottom plate 18 exists over a range wider than that in Embodiment 1.

When the first shield 50 is integrated with the first housing 11 by over-molding or insert molding, about upper half of the base end part 55a and the first vertical part 55b are integrated with a portion of the corner parts 17 more on the inner side than the separation protruding part 17f in the longitudinal direction of the first connector 10 to be exposed on the surfaces of the upper wall part 17a and the inner wall part 17c, and only a portion of the first horizontal part 55c in the vicinity of the tip end thereof is integrated with the bottom plate 18 to be exposed on the lower surface of the bottom plate 18. This ensures that the long side part 50a and the first housing 11 are firmly integrated and cannot be separated. A portion other than the portion in the vicinity of the tip end of the first horizontal part 55c and the entire portion of the contact pieces 55f are positioned in the side recess extension part 18d while being separated from the bottom plate 18. As a result, the contact pieces 55f can freely deform in the mating direction, and the vertex 55g thereof can freely deform in the mating direction.

As clearly illustrated in FIG. 31, the contact pieces 55f are disposed in the vicinity of the four corner parts of the substantially rectangular first shield 50 in plan view. The vertices 55g that are the contact points of the contact pieces 55f are positioned outside a region where the mating spring part 51a as a portion that comes into contact with the second shield 150 exists, on the four sides of the substantially rectangular first shield 50. Specifically, the vertices are positioned more on the outer side in the longitudinal direction of the first connector 10 than the mating spring part 51a of the long side part 50a, and are positioned more on the outer side in the width direction of the first connector 10 than the mating spring part 51a in the short side part 50b.

The contact pieces 55f extend over the entire range of the cutout part 50c separating the long side part 50a and the short side part 50b of the first shield 50 from each other in the longitudinal direction of the first connector 10 in side view. Thus, improvement can be achieved in terms of the leakage of the electromagnetic shield in the cutout part 50c.

Note that a configuration of another point of the first connector 10 in the present embodiment is the same as that of embodiment 1 described above, and therefore, a description thereof is omitted.

Next, the configuration of the second connector 101 according to the present Embodiment will be described.

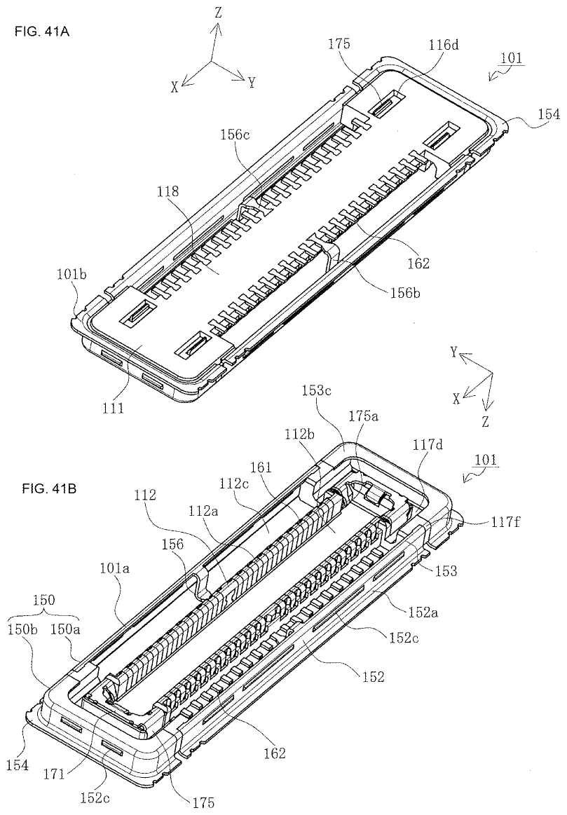

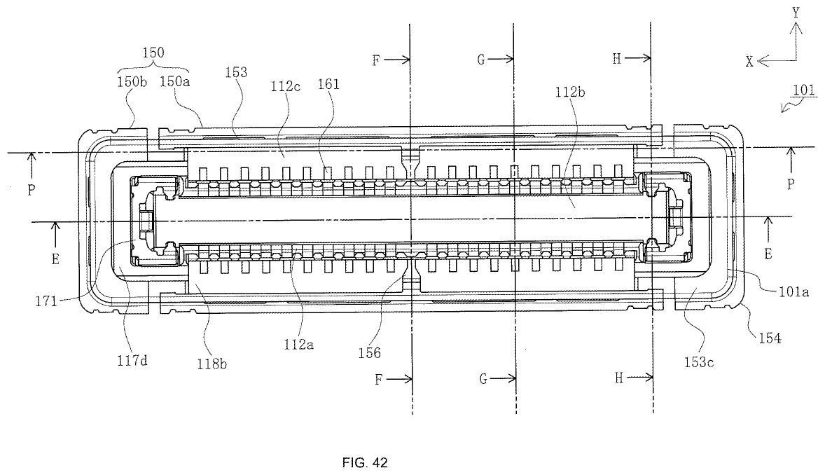

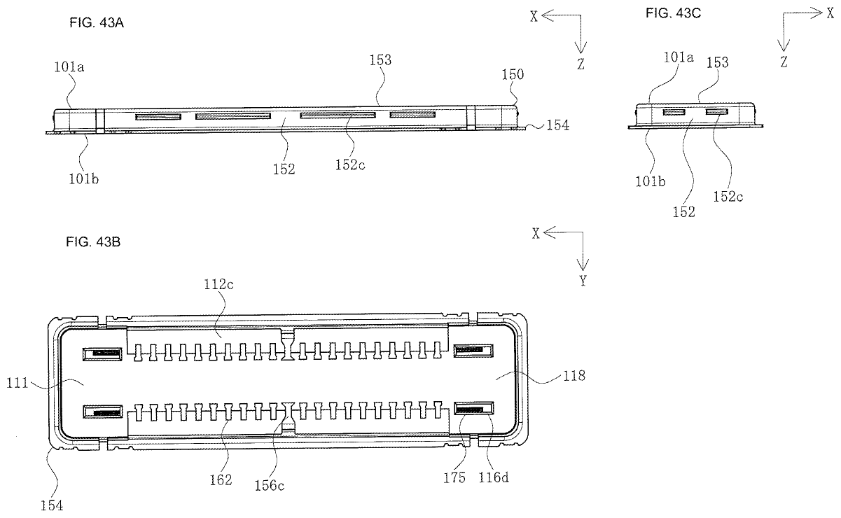

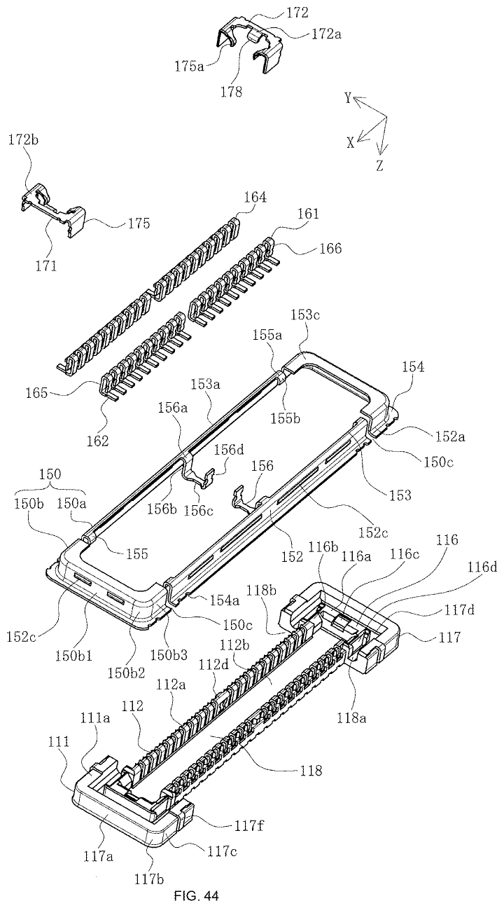

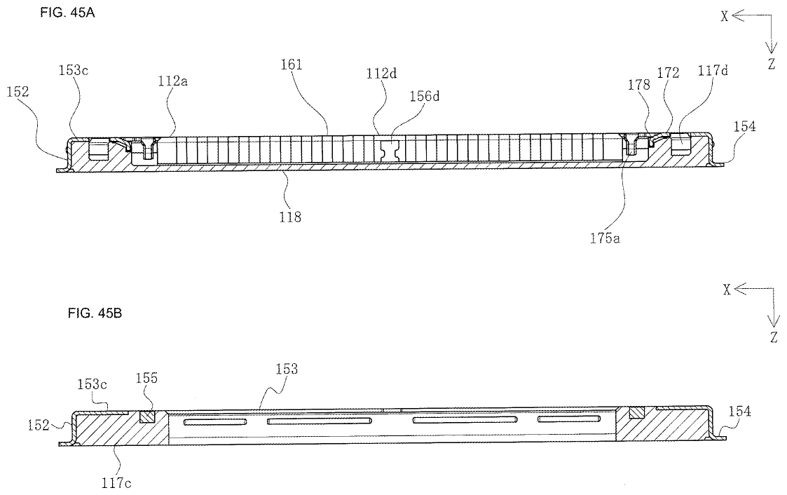

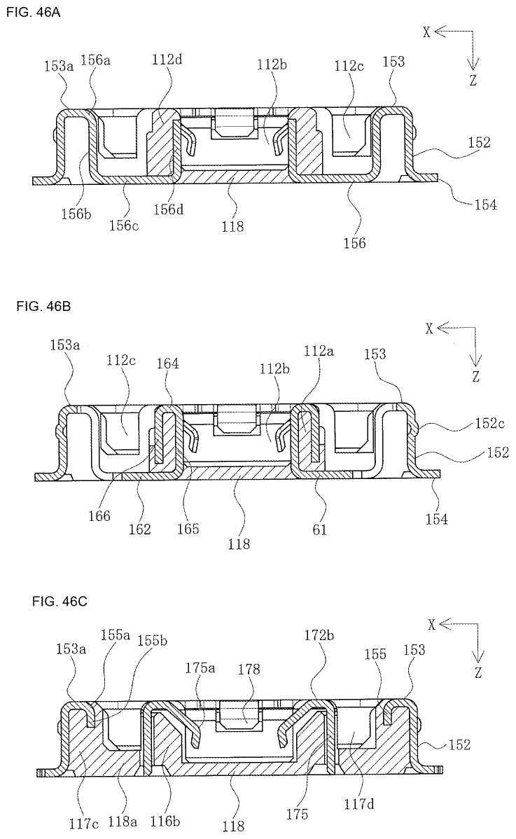

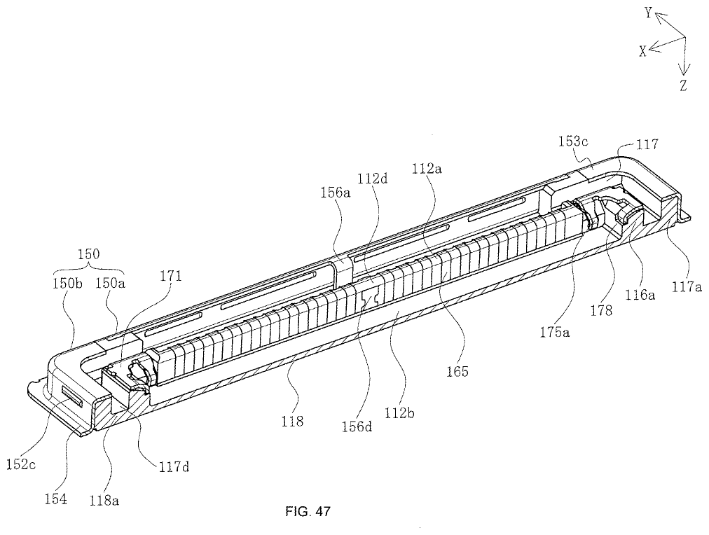

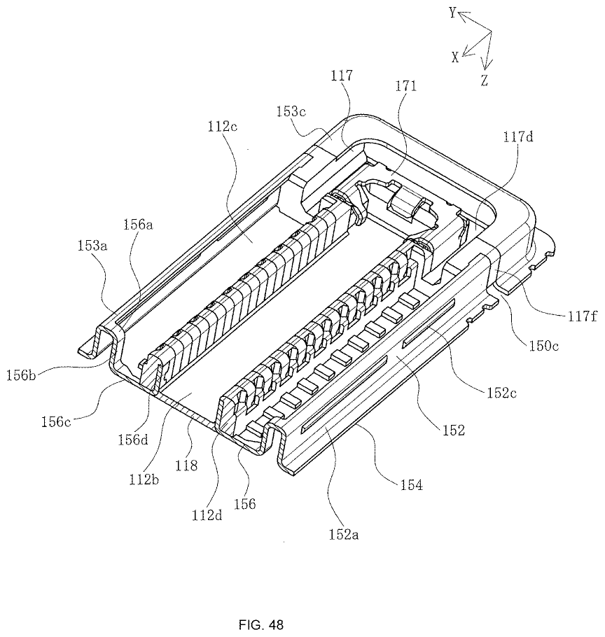

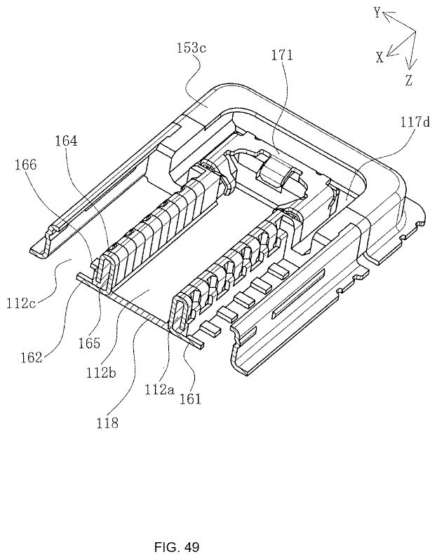

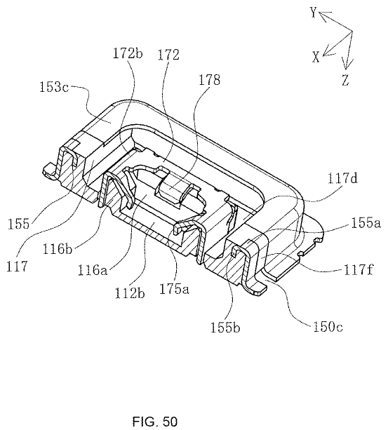

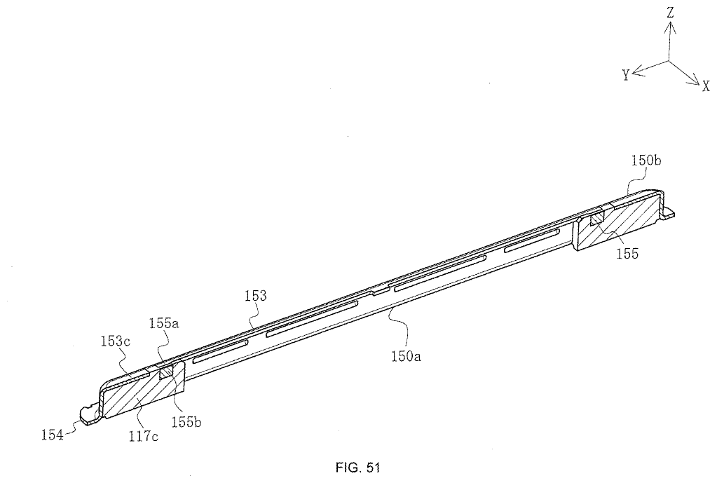

FIG. 41 is a perspective view of a second connector according to Embodiment 2, FIG. 42 is a top view of the second connector according to Embodiment 2, FIG. 43 includes three views of the second connector according to Embodiment 2, FIG. 44 is an exploded perspective view of the second connector according to Embodiment 2, FIG. 45 is a side cross-sectional view of the second connector according to Embodiment 2, FIG. 46 is a traverse cross-sectional view of the second connector according to Embodiment 2, FIG. 47 is a first perspective one-side cross-sectional view of the second connector according to Embodiment 2 and is a perspective one-side cross-sectional view taken along line E-E in FIG. 42, FIG. 48 is a second perspective one-side cross-sectional view of the second connector according to Embodiment 2 and is a perspective one-side cross-sectional view taken along line F-F in FIG. 42, FIG. 49 is a third perspective one-side cross-sectional view of the second connector according to Embodiment 2 and is a perspective one-side cross-sectional view taken along line G-G in FIG. 42, FIG. 50 is a fourth perspective one-side cross-sectional view of the second connector according to Embodiment 2 and is a perspective one-side cross-sectional view taken along line H-H in FIG. 42, and FIG. 51 is a fifth perspective one-side cross-sectional view of the second connector according to Embodiment 2 and is a perspective one-side cross-sectional view taken along line P-P in FIG. 42. In FIG. 41, (a) is an obliquely downward view, (b) is an obliquely upward view. In FIG. 43, (a) is a side view, (b) is a bottom view, and (c) is a front view. In FIG. 45, (a) is a cross-sectional view taken along a line indicated by arrows E-E in FIG. 42 and (b) is a cross-sectional view taken along a line indicated by arrows P-P in FIG. 42. In FIG. 46, (a) is a cross-sectional view taken along a line indicated by arrows F-F in FIG. 42, (b) is a cross-sectional view taken along a line indicated by arrows G-G in FIG. 42, (c) is a cross-sectional view taken along a line indicated by arrows H-H in FIG. 42.

In the present Embodiment, the second shield 150 includes a shield upper surface part provided on an upper surface 111a of the second housing 111, and the contact pieces 55f of the first connector 10 come into contact with the shield upper surface part.

Specifically, as illustrated in FIG. 44, in the present Embodiment, the side wall parts 117c of the protruding end part 117 of the second housing 111 is formed to have a large dimension in the width direction and have a large planer portion in the upper surface compared with the side wall parts 117c according to Embodiment 1. In the present Embodiment, the upper surface of the protruding end part 117 is referred to as the upper surface 111a of the second housing 111.

The upper wall part 153c of the short side part 150b of the second shield 150 is formed to have the portion corresponding to the side wall parts 117c having a large dimension in the width direction compared with that in Embodiment 1, and the upper wall part 153c is referred to as the shield upper surface part in the present Embodiment.

When the first connector 10 and the second connector 101 mate, the protruding end part 117 is inserted in the mating recess part 12b of the first connector 10, and the contact pieces 55f positioned within the mating recess 12b come into contact with the upper wall part 153c disposed at a portion of the upper surface 111a corresponding to the side wall parts 117c. Thus, in the completed mating state of the first connector 10 and the second connector 101, the vertex 55g of the contact piece 55f comes into contact with the shield upper surface part of the second shield 150 in the vicinity of each corner part. Thus, extremely high electromagnetic shielding effect can be achieved also in the vicinity of each corner part.

Note that a configuration of another point of the second connector 101 in the present embodiment is the same as that of Embodiment 1 described above, and therefore, a description thereof is omitted.

Subsequently, the operation of mating together the first connector 10 and the second connector 101 with the present Embodiment will be described.

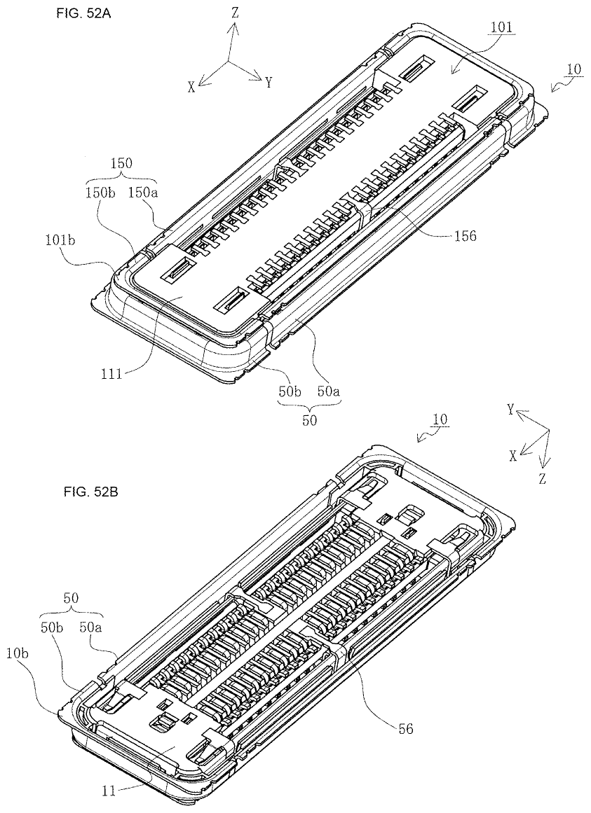

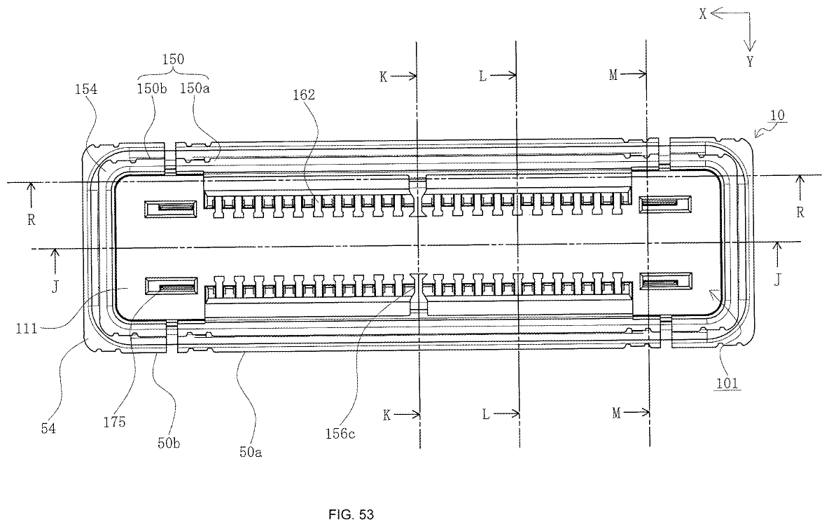

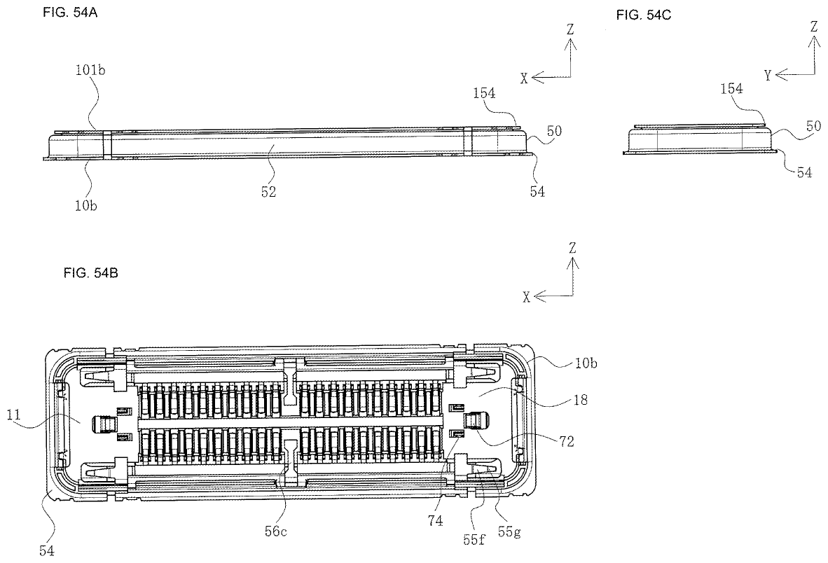

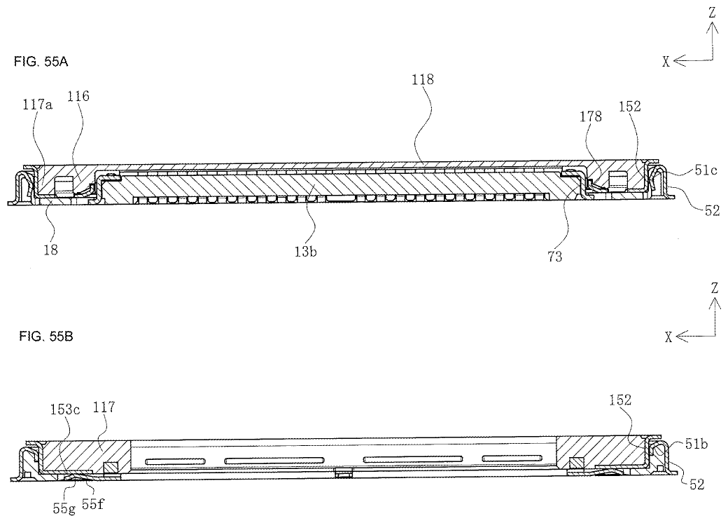

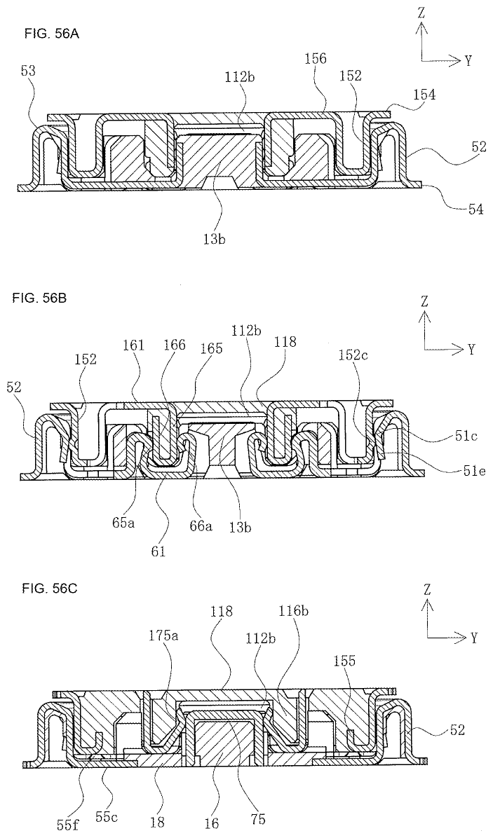

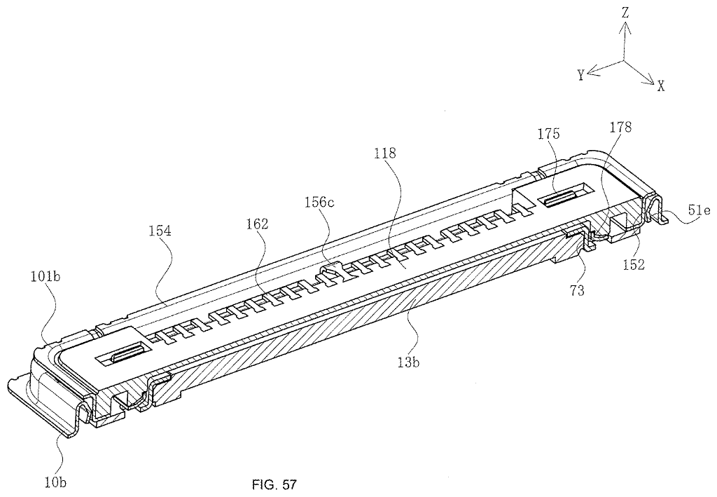

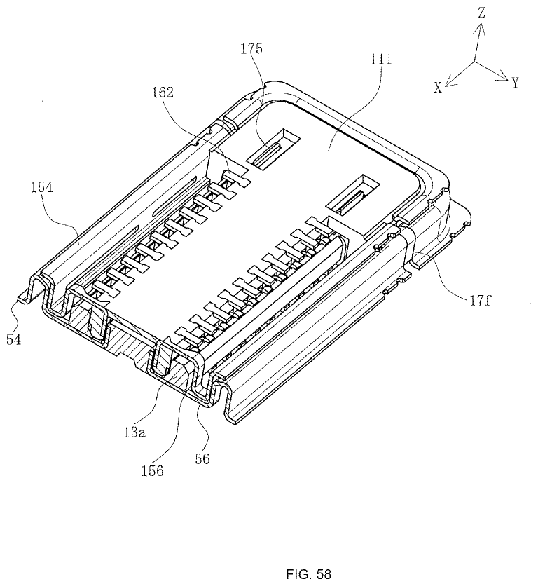

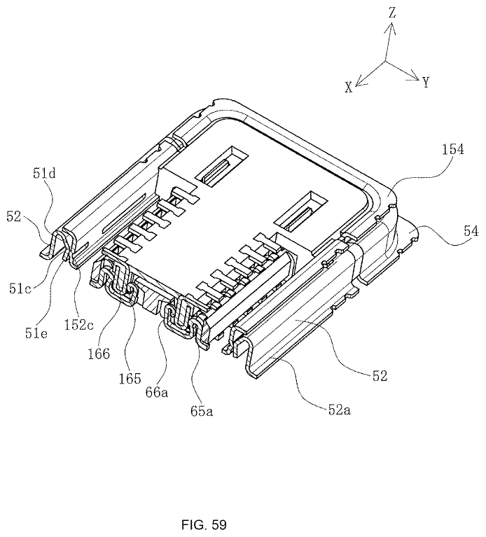

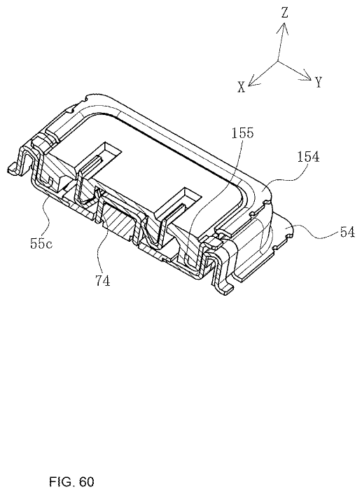

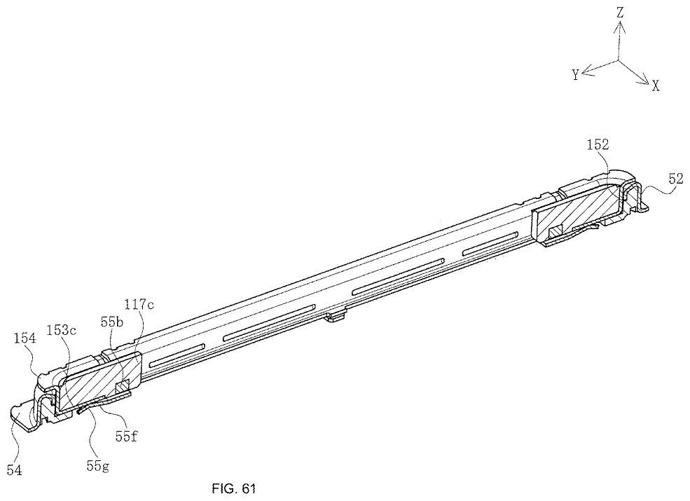

FIG. 52 is a perspective view of a completed mating state of the first connector and the second connector according to Embodiment 2, FIG. 53 is a plan view of the completed mating state of the first connector and the second connector according to Embodiment 2 as viewed from above the first connector, FIG. 54 includes three views of the completed mating state of the first connector and the second connector according to Embodiment 2, FIG. 55 is a side cross-sectional view of the completed mating state of the first connector and the second connector according to Embodiment 2, FIG. 56 is a traverse cross-sectional view of the completed mating state of the first connector and the second connector according to Embodiment 2, FIG. 57 is a first perspective one-side cross-sectional view of the completed mating state of the first connector and the second connector according to Embodiment 2 and is a cross-sectional view taken along a line indicated by arrows J-J in FIG. 53, FIG. 58 is a second perspective one-side cross-sectional view of the completed mating state of the first connector and the second connector according to Embodiment 2 and is a cross-sectional view taken along a line indicated by arrows K-K in FIG. 53, FIG. 59 is a third perspective one-side cross-sectional view of the completed mating state of the first connector and the second connector according to Embodiment 2 and is a cross-sectional view taken along a line indicated by arrows L-L in FIG. 53, FIG. 60 is a fourth perspective one-side cross-sectional view of the completed mating state of the first connector and the second connector according to Embodiment 2 and is a perspective one-side cross-sectional view taken along a line indicated by arrows M-M in FIG. 43, and FIG. 61 is a fifth perspective one-side cross-sectional view of the completed mating state of the first connector and the second connector according to Embodiment 2, and is a perspective one-side cross-sectional view taken along line R-R in FIG. 43. In FIG. 52, (a) is an obliquely upward view of the first connector, (b) is an obliquely downward view of the first connector. In FIG. 54, (a) is a side view, (b) is a plan view of the second connector as viewed from above, and (c) is a front view. In FIG. 55, (a) is a cross-sectional view taken along a line indicated by arrows J-J in FIG. 53 and (b) is a cross-sectional view taken along a line indicated by arrows R-R in FIG. 53. In FIG. 56, (a) is a cross-sectional view taken along a line indicated by arrows K-K in FIG. 53, (b) is a cross-sectional view taken along a line indicated by arrows L-L in FIG. 53, (c) is a cross-sectional view taken along a line indicated by arrows M-M in FIG. 53.

In the present Embodiment, when the first connector 10 and the second connector 101 mate, the protruding end part 117 of the second housing 111 is inserted in the mating recess part 12b of the first connector 10, and the upper wall part 153c of the second shield 150 disposed at the portion of the upper surface 111a of the second housing 111 corresponding to the side wall parts 117c comes into contact with the vertex 55g of the contact piece 55f positioned within the mating recess part 12b, to make the vertex 55g displaced downward (Z-axis negative direction). Then, the contact piece 55f of a cantilever shape is elastically deformed, and the resultant reaction force presses the vertex 55g against the upper wall part 153c.

As a result, the contact between the vertex 55g of the contact piece 55f and the upper wall part 153c is reliably maintained. Thus, the connection between the long side part 50a of the first shield 50 to which the contact piece 55f is connected and the short side part 150b of the second shield 150 including the upper wall part 153c is reliably maintained. The long side part 50a of the first shield 50 and the long side part 150a of the second shield 150 come into contact with each other. The short side part 50b of the first shield 50 and the short side part 150b of the second shield 150 come into contact with each other. Thus, the long side part 50a and the short side part 50b of the first shield 50 and the long side part 150a and the short side part 150b of the second shield 150 are connected to each other and the equipotential can be maintained, whereby even better electromagnetic compatibility (EMC) can be maintained.

Note that the other points of the operation of mating the first connector 10 and the second connector 101 in the present Embodiment is the same as that of Embodiment 1 described above; therefore, a description thereof is omitted.

As described above, in the present Embodiment, the first connector 10 includes the first housing 11, the plurality of first terminals 61 attached to the first housing 11, and the first shield 50 that surrounds the first housing 11, and mates with the second connector 101. The first terminals 61 are arranged to form rows extending in the longitudinal direction of the first connector 10. The first shield 50 has a substantially rectangular shape in plan view with the four sides coming into contact with the second shield 150 of the second connector 101. The first connector 10 includes contact pieces 55f that are elastically displaceable in the mating direction and are disposed in the vicinity of the four corner parts of the first shield 50. The contact pieces 55f come into contact with the second shield 150 of the second connector 101.

Thus, the first connector 10 can have high strength while being compact and low profile, and can further provide high shielding effect to achieve improved reliability.

The vertex 55g of the contact piece 55f comes into contact with the second shield 150 outside a region where the four sides of the first shield 50 come into contact with the second shield 150 in plan view. The contact pieces 55f are connected to the first shield 50. The contact pieces 55f have a cantilever shape extending in the longitudinal direction of the first connector 10. The second shield 150 includes the upper wall part 153c disposed on the upper surface 111a of the second housing 111, and the contact pieces 55f come into contact with the upper wall part 153c.

Note that the basic configuration and effect of the mating state of the first connector 10 and the second connector 101 is the same as that of Embodiment 1 described above; therefore, a description thereof is omitted.

Moreover, the disclosure herein describes features relating to suitable typical embodiments. Various other Embodiments, modifications, and variations within the scope and spirit of the claims appended hereto will naturally be conceived of by those skilled in the art upon review of the disclosure herein.

The present disclosure can be applied to a connector and a connector pair.

1. A connector comprising:
a connector main body;
a plurality of terminals attached to the connector main body; and
a shielding member surrounding the connector main body, the connector mating with a mating connector, wherein the terminals are arranged to form rows extending in a longitudinal direction of the connector, the shielding member includes a fixing part, a shielding plate, and a joint part, the fixing part integrally connects and fixes the shielding member to the connector main body with no gap in between, in vicinity of both ends of the connector main body in the longitudinal direction, the shielding plate is disposed on outer side of the connector main body in a width direction, in a range at least corresponding to the rows of the terminals, in the longitudinal direction of the connector, with a side space provided in between, and the joint part connects the shielding plate to the connector main body across the side space in the range corresponding to the rows of the terminals.

2. The connector according to claim 1, wherein the joint part extends from an upper end of the shielding plate toward a mounting surface of the connector, further extends toward the connector main body, and has a tip end fixed to the connector main body between ones of the terminals adjacent to each other in the longitudinal direction of the connector.

3. The connector according to claim 1, wherein part of the joint part is electrically connectable to a substrate on which the connector is mounted.

4. The connector according to claim 1, wherein a substrate connecting part parallel to a surface of a substrate on which the connector is mounted is formable on the shielding plate.

5. The connector according to claim 1, wherein the shielding member is able to include a second shielding member surrounding both ends of the connector main body in the longitudinal direction.

6. The connector of claim 5, wherein the second shielding member is able to be integrated with the shielding member.

7. The connector according to claim 1, wherein the shielding member surrounds periphery of a housing part in which the mating connector is inserted and housed, the shielding plate includes at least two contacting parts configured to come into contact with a shielding plate of the mating connector, and the joint part is formed between adjacent ones of the contacting parts.

8. The connector according to claim 1, wherein the shielding plate is able to include a contact part formed to protrude outward from an outer surface.

9. A connector comprising:
a connector main body;
a plurality of terminals attached to the connector main body; and
a shielding member surrounding the connector main body, the connector mating with a mating connector, wherein the terminals are arranged to form rows extending in a longitudinal direction of the connector, the shielding member has a substantially rectangular shape in plan view, and has four sides configured to come into contact with a shielding member of the mating connector, the connector includes contact pieces that are disposed in vicinity of four corner parts of the shielding member and are elastically displaceable in a mating direction, and the contact pieces are configured to come into contact with the shielding member of the mating connector.

10. The connector according to claim 9, wherein contact points of the contact pieces are configured to come into contact with the shielding member of the mating connector outside a region where the four sides of the shielding member come into contact with the shielding member of the mating connector in plan view.

11. The connector according to claim 9, wherein the contact pieces are connected to the shielding member.

12. The connector according to claim 9, wherein the contact pieces have a cantilever shape extending in the longitudinal direction of the connector.

13. The connector according to claim 9, wherein the shielding member of the mating connector includes a shield upper surface part disposed on an upper surface of a connector main body of the mating connector, and the contact pieces are configured to come into contact with the shield upper surface part.

14. A connector pair, comprising:
the connector described in claim 1; and
a mating connector that mates with the connector.
